(19) United States
(12) Patent Application Publication
(10) Pub. No.: US 2005/0007019 A1
(43) Pub. Date: Jan. 13, 2005

(54) Surface light source device, method of manufacturing the same, backlight assembly and liquid crystal display apparatus having the same

(76) Inventors: Hyoung-Joo Kim, Uiwang-si (KR); Hyeon-yong Jang, Osan-si (KR); Jin-Seob Byun, Seoul (KR); Joong-Hyun Kim, Yongin-si (KR)

Correspondence Address: CANTOR COLBURN LLP, 55 Griffin Road South, Bloomfield, CT, 06002, US

(21) Appl. No.: 10/840,813

(22) Filed: May 7, 2004

(30) Foreign Application Priority Data
Jul. 12, 2003 (KR) 2003-47579

(51) Int. Cl. H01J 63/04; H01J 1/62

(52) U.S. Cl. 313/607; 313/495; 313/634

(57) ABSTRACT

A surface light source device capable of emitting the light having uniform brightness with lower power consumption is provided. The surface light source device includes a light source body and at least one discharge voltage applying part. The light source body includes a bottom plate; a top plate which is disposed over the bottom plate to form a flat receiving space between the bottom plate and the top plate, the flat receiving space receiving discharge gas; and at least one space-dividing wall which is disposed on the bottom plate and divides the flat receiving space into at least two discharge spaces. The discharge voltage applying part is disposed on an outer surface of the light source body and applies discharge voltage to the light source body.

### BACKGROUND OF INVENTION

1. Field of the Invention

The present invention relates to a surface light source device, a method of manufacturing the same, a backlight assembly and a liquid crystal display (LCD) apparatus having the same, and more particularly, to a surface light source device capable of emitting the light having a uniform brightness with lower power consumption, a method of manufacturing the same, a backlight assembly and an LCD apparatus having the same.

2. Description of the Related Art

Liquid crystals have physical properties of both solid and fluid, electrical properties of different arrangement in accordance with an electric field, and optical properties of different light transmittance in accordance with the arrangements. Liquid Crystal Display (LCD) apparatuses display images using the liquid crystals. Because LCD apparatuses have many advantages such as thinner, smaller, lower power consumption, higher resolution, etc., they are widely applied to electronic devices, for example, laptop computer, monitors, mobile communications systems and so on.

LCD apparatuses include a liquid crystal control part for controlling the liquid crystals and a light supply part for supplying light to the liquid crystals. The liquid crystal control part includes a plurality of pixel electrodes and one common electrode. The liquid crystals are disposed between the pixel and common electrodes. Each of the pixel electrodes is connected to a thin film transistor (TFT) to which a pixel voltage is applied, and the common electrode receives a reference voltage. The light is supplied from the light supply part and is sequentially transmitted to the pixel electrodes, the liquid crystal and the common electrode.

There are LCD apparatuses employing a cold cathode fluorescent lamp (CCFL) as the light supply part. CCFLs have advantages such as a higher brightness, a longer life, a white light generation and a smaller amount of heating. However, since CCFLs have less brightness uniformity, LCD apparatuses employing CCFLs as the light supply part require an optical member such as a light guide plate (LGP), a diffusion member and a prism sheet or the like in order to supply the light of the uniform brightness, and become bigger and heavier. Thus, there is a need for LCD apparatuses, which has higher brightness as well as improved brightness uniformity.

### BRIEF SUMMARY OF THE INVENTION

The present invention provides a surface light source device capable of improving the brightness and brightness uniformity of emitted light with lower power consumption.

The present invention further provides a method for manufacturing the surface light source device, capable of improving the brightness and brightness uniformity of emitted light with lower power consumption.

The present invention still further provides a backlight assembly having the surface light source device and capable of lowering power consumption, generating the light having a uniformed brightness and decreasing manufacturing cost.

The present invention still further provides an LCD apparatus having the surface light source device and capable of lowering power consumption, generating the light having a uniformed brightness and decreasing manufacturing cost.

According to one aspect of the present invention, a surface light source device comprises a light source body including: a bottom plate; a top plate which is disposed over the bottom plate to form a flat receiving space between the bottom plate and the top plate, the flat receiving space receiving discharge gas; and at least one space-dividing wall which is disposed on the bottom plate and divides the flat receiving space into at least two discharge spaces; and at least one discharge voltage applying part which is disposed on an outer surface of the light source body and applies discharge voltage to the light source body.

According to another aspect of the present invention, a surface light source device comprises a light source body including: a flat bottom surface; first to fourth sidewalls each perpendicular to the bottom surface, the first and second sidewalls facing each other and the third and fourth sidewalls facing each other, a light exit surface disposed on the first to fourth sidewalls and over the bottom surface, wherein the first to fourth sidewalls and the light exit surface define a flat receiving space to receive discharge gas; at least one space-dividing portion integrally formed with the bottom surface or the light exit surface to divide the flat receiving space into at least two discharge spaces, the space dividing portion being extended in a direction perpendicular to the first and second sidewalls; and at least two fluorescent layers each surrounding the discharge spaces; and at least one discharge voltage applying part disposed at an outer surface of the light source body in a direction perpendicular to a longitudinal direction of the space-dividing portion, the discharge voltage applying parts applying discharge voltage to the light source body to generate a visible ray from the discharge gas via the fluorescent layers.

According to another aspect of the present invention, a surface light source device comprises a first substrate including: a first transparent substrate which includes a first light exiting area and a first sealing area surrounding the first light exiting area, the first transparent substrate being flat and rectangular; at least one space-dividing wall which is disposed at the first light exiting area and divides the first light exiting area into at least two discharge spaces; a light reflecting layer which is disposed on the first transparent area and the space-dividing wall; and a first fluorescent layer which is disposed on the light reflection layer, a second substrate including: a second transparent substrate which includes a second light exiting area and a second sealing area surrounding the second light exiting area; and a second fluorescent layer which is disposed on the second light exiting area of the second transparent substrate, the second fluorescent layer facing the first fluorescent layer of the first substrate; a sealing member which is disposed between the first and second sealing areas of the first and second transparent substrates; and at least one discharge voltage applying part which is disposed on outer surfaces of the first and second substrates in a direction perpendicular to a longitudinal direction of the space-dividing wall.

According to another aspect of the present invention, a surface light source device comprises a first substrate; a second substrate which is disposed on the first substrate, wherein the second substrate includes at least two protrusions having a predetermined height with respect to the first substrate, the protrusions extending in a longitudinal direction of the second substrate and arranging with spaces and in parallel to each other, at least two discharge spaces which are formed between the first substrate and the protrusions of the second substrate; and at least one discharge voltage applying part disposed on an outer surface of the second substrate in an opposite direction to the longitudinal direction of the second substrate, wherein one end of each of the discharge spaces is connected to the at least one discharge voltage applying part.

According to another aspect of the present invention, a method for manufacturing a surface light source body, comprises forming a first substrate; forming a second substrate to include at least two protrusions having a predetermined height with a bottom of the second substrate, wherein the at least two protrusions extend in a longitudinal direction of the second substrate and arrange with spaces and in parallel to each other; adhering edges of the first and second substrates, wherein inner surface of the protrusions of the second substrate face an inner surface of the first substrate and a space between the first and second substrates is divided into at least two discharge spaces; and forming at least one discharge voltage applying part on an outer surface of the second substrate in an opposite direction to the longitudinal direction of the second substrate to discharge the discharge spaces.

According to another aspect of the present invention, a method for manufacturing a surface light source body, comprises forming a first light source body including a light exit surface and a first fluorescent layer disposed on the light exit surface; forming a second light source body including a flat receiving space; forming at least one space-dividing wall in the receiving space of the second light source body to divide the receiving space into at least two discharge spaces; disposing a second fluorescent layer on the second light source body in which the space-dividing wall is formed; assembling the first and second source light bodies, wherein the first and second fluorescent layers face each other, and forming at least one discharge voltage applying part on an outer surface of the assembled first and second light source bodies to generate discharging in the discharge spaces.

According to another aspect of the present invention, a method for manufacturing a surface light source device, comprises forming a first transparent substrate to include a light exiting area and a sealing area disposed at edges of the light exiting area, the first transparent substrate having a flat and substantially rectangular shape; forming at least one space-dividing wall on the light exiting area of the first transparent substrate to divide the light exiting area into at least two discharge areas; forming a light reflection layer on the first transparent substrate and the space-dividing wall; forming a first fluorescent layer on the light reflection layer, forming a second transparent substrate having a shape substantially identical to the shape of the first transparent substrate; forming a second fluorescent layer on the second transparent substrate; assembling the first transparent substrate, on which the space-dividing wall, the light reflection layer and the first fluorescent layer are disposed, and the second transparent substrate on which the second fluorescent layer is disposed, by employing a sealing member, wherein the first and second fluorescent layers face each other, and forming at least one discharge voltage applying part on an outer surface of the assembled first and second transparent substrates.

According to another aspect of the present invention, a backlight assembly, comprises: a surface light source device, including: a light source body including: a first substrate; a second substrate which is disposed on the first substrate; at least two discharge spaces which is formed between first and second substrates; and at least two fluorescent layers each surrounding the discharge spaces; and at least one discharge voltage applying part disposed at an outer surface of the light source body to apply discharge voltage to the light source body to generate a visible ray from the discharge gas via the fluorescent layers; and a receiving container to receive the surface light source body.

According to further aspect of the present invention, a liquid crystal display apparatus, comprises: a surface light source device, including: a light source body, including: a first substrate; a second substrate which is disposed on the first substrate; at least two discharge spaces which is formed between first and second substrates; and at least two fluorescent layers each surrounding the discharge spaces; and at least one discharge voltage applying pail which is disposed at an outer surface of the light source body and applies discharge voltage to the light source body to generate a visible ray from the discharge gas via the fluorescent layers; a receiving container which receives the surface light source body; and a liquid crystal display panel which is disposed on the surface light source device and is received in the receiving container, the liquid crystal display panel receiving light emitted from the surface light source device and displaying an image using the receiving light.

This application claims a priority upon Korean Patent Application No. 2003-47579 filed on Jul. 12, 2003, the contents of which are herein incorporated by reference in its entirety.

### BRIEF DESCRIPTION OF THE DRAWINGS

The above and other advantages of the present invention will become readily apparent by reference to the following detailed description when considered in conjunction with the accompanying drawings wherein:

FIG. 1 is a perspective view showing a surface light source device according to an exemplary embodiment of the present invention;

FIG. 2 is a cross-sectional view taken along the line A-A′ of FIG. 1;

FIG. 3 is a perspective view showing a surface light source device according to another exemplary embodiment of the present invention;

FIG. 4 is an enlarged view showing a portion “B” of FIG. 3;

FIG. 5 is a perspective view showing a surface light source device according to another exemplary embodiment of the present invention;

FIG. 6 is an enlarged view showing a portion “C” of FIG. 5;

FIG. 7 is a partially exploded perspective view showing a surface light source device according to another exemplary embodiment of the present invention;

FIG. 8 is a perspective view showing a surface light source device according to another exemplary embodiment of the present invention;

FIG. 9 is a cross-sectional view taken along the line D-D′ of FIG. 8;

FIG. 10 is a perspective view showing a surface light source device according to another exemplary embodiment of the present invention;

FIG. 11 is a cross-sectional view taken along the line E-E′ of FIG. 10;

FIG. 12 is a perspective view showing a surface light source device according to another exemplary embodiment of the present invention;

FIG. 13 is a perspective view showing a surface light source device according to another exemplary embodiment of the present invention;

FIG. 14 is perspective view showing a surface light source device according to another exemplary embodiment of the present invention;

FIG. 15 is a cross-sectional view taken along the ling F-F′ of FIG. 14;

FIG. 16 is a schematic view showing a surface light source according to another exemplary embodiment of the present invention;

FIG. 17 is a perspective view showing a surface light source device according to another exemplary embodiment of the present invention;

FIG. 18 is a cross-sectional view taken along the line G-G′ of FIG. 17;

FIG. 19 is a perspective view showing a surface light source device according to another exemplary embodiment of the present invention;

FIG. 20 is an enlarged view showing a portion “H” of FIG. 19;

FIG. 21 is a perspective view showing a surface light source device according to another exemplary embodiment of the present invention;

FIG. 22 is an enlarged view showing a portion “T” of FIG. 21;

FIG. 23 is an exploded perspective view showing a surface light source device according to another exemplary embodiment of the present invention;

FIG. 24 is a cross-sectional view taken along the line J-J′ of FIG. 23;

FIG. 25 is an enlarged view showing a portion “K” of FIG. 24;

FIG. 26 is a prospective view showing a surface light source device according to another exemplary embodiment of the present invention;

FIG. 27 is a cross-sectional view taken along the line L-L′ of FIG. 26;

FIG. 28 is a flow chart illustrating a method of a surface light source device according to another exemplary embodiment of the present invention;

FIG. 29 is a perspective view showing a first light source body and a second light source body illustrated in the flow chart of FIG. 28;

FIG. 30 is a schematic view showing a flowable paste coated on the second light source body illustrated in the flow chart of FIG. 28;

FIG. 31 is a perspective view showing a discharge voltage applying part coupled with the first and second light source bodies, illustrated in the flow chart of FIG. 28;

FIG. 32 is a perspective view showing a light source body according to another exemplary embodiment of the present invention;

FIGS. 33 to 35 are schematic views illustrating a method of forming a discharge voltage applying part according to another exemplary embodiment of the present invention;

FIGS. 36 and 37 are schematic views illustrating a method of forming a surface light source device according to another exemplary embodiment of the present invention;

FIGS. 38 and 39 are schematic views illustrating a method of forming a surface light source device according to another exemplary embodiment of the present invention;

FIGS. 40A to 40G are schematic views illustrating a method of manufacturing a surface light source device according to another exemplary embodiment of the present invention;

FIG. 41 is an exploded perspective view showing a backlight assembly according to another exemplary embodiment of the present invention; and

FIG. 42 is an exploded perspective view showing an LCD apparatus according to a further exemplary embodiment of the present invention.

### DETAILED DESCRIPTION OF THE INVENTION

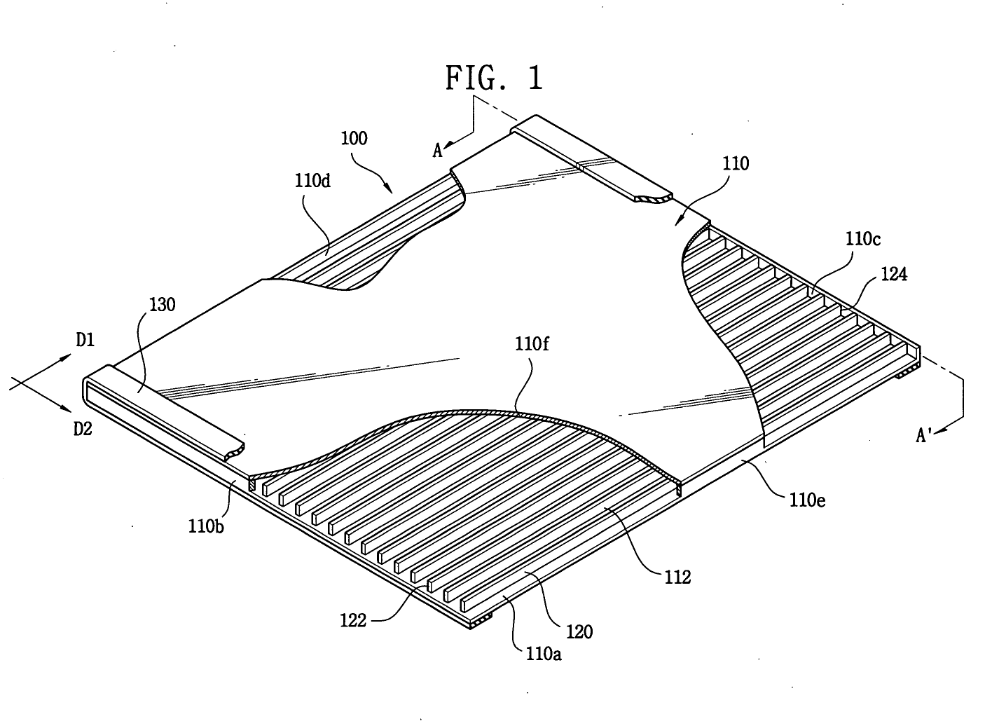

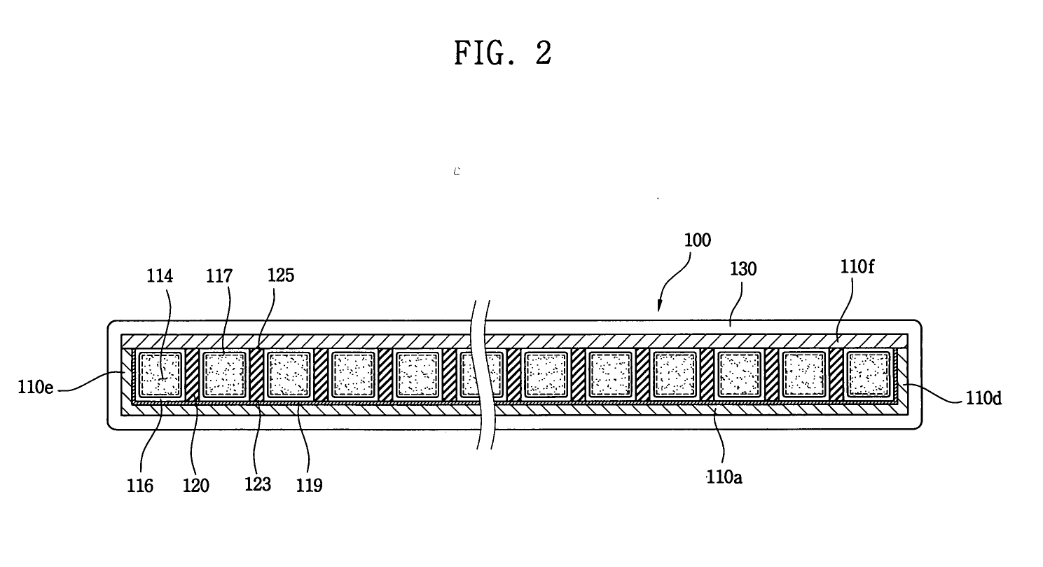

FIG. 1 is a perspective view showing a surface light source device according to an exemplary embodiment of the present invention. FIG. 2 is a cross-sectional view taken along the line A-A′ of FIG. 1. Referring to FIGS. 1 and 2, a surface light source device 100 includes a light source body 110, at least one space-dividing wall 120 and a pair of discharge voltage applying parts 130.

The light source body 110 includes a bottom surface 110a, first, second, third and fourth sidewalls 110b, 110c, 110d and 110e, a light exit surface 110f, at least two fluorescent layers 116 and a light reflection layer 119. The bottom surface 110a includes a flat and substantially rectangular shape. The first, second, third and fourth sidewalls 110b, 110c, 110d and 110e are substantially perpendicular to the bottom surface 110a, and the sidewalls 110b-110e and the bottom surface 110a form a flat receiving space 112 in the light source body 110 together. The sidewalls 110b-110e each have, for example, a height of about 2.4 mm. The first and second sidewalls 110b and 110c face each other, and the third and fourth sidewalls Hod and hoe face each other. The first, second, third and fourth sidewalls 110b, 110c, 110d and 110e may have a material different from or equal to that of the bottom surface 110a.

The light exit surface 110f is disposed over the flat receiving space 112 formed by the first, second, third and fourth sidewalls 110b, 110c, 110d and 10e, and the bottom surface 110a. The light exit surface 110f has the same rectangular shape as the bottom surface 110a. Thus, the flat receiving space 112 is defined by the bottom surface 110a, the first to fourth sidewalls 110b-110e and the light exit surface 110f.

The first to fourth sidewalls 110b-110e may be assembled with the bottom surface 110a and the light exit surface 110f, after forming the flat bottom surface 110a and the light exit surface 110f, separately, or the sidewalls 110b-110e may be integrally formed with the flat bottom surface 110a or the light exit surface 110f and then coupled to the flat light exit surface 110f or the bottom surface 110a.

The flat receiving space 112 receives a discharge gas 114 generating an invisible ray. The discharge gas 114 includes a combination gas of mercury (Hg) with at least one of an argon gas, a neon gas, a xenon gas and a krypton gas. The mercury (Hg) may be replaced with another discharge gas. The flat receiving space 112 is divided into at least two discharge spaces 117 with at least one space-dividing wall 120. The space-dividing wall 120 is extended in a first direction D1 and arranged in a second direction D2 in the flat receiving space 112. The space-dividing wall 120 includes a first end 122 coupled to the first sidewall 110b, a second end 124 opposite to the first end 122 and coupled to the second sidewall 110c, a lower surface 123 coupled to the bottom surface 110a and an upper surface 125 coupled to the light exit surface 110f.

The fluorescent layer 116 is formed to surround the discharge space 117 in the light source body 110 and contacts with the space-dividing wall 120. The fluorescent layer 116 includes three fluorescent materials, for example, a red fluorescent material, a green fluorescent material and a blue fluorescent material, in the same quantity to each other. The ed, green and blue fluorescent materials change the invisible ray of the discharge gas into a red visible ray, a green visible ray and a blue visible ray, respectively, and the red, green and blue visible rays in the same quantity to each other are mixed to generate a white light.

The light reflection layer 119 shown in FIG. 2 is formed on the inner surfaces of the bottom surface 110a and the first to fourth sidewalls 110b-110e. The light reflection layer 119 reflects the light generated from the discharge spaces 117 to the light exit surface 110f, and improves the brightness of the light exited through the light exit surface 110f.

The pair of discharge voltage applying parts 130 is disposed on the outer surface of the light source body 110 and applies discharge voltage to the light source body to cause the discharging in the discharge spaces 117. The discharge voltage applying parts 130 are arranged in the second direction D2 substantially perpendicular to a longitudinal direction of the space-dividing wall 120. The discharge voltage applying parts 130, for example, have a band shape closely adhered to the outer surface of the light source body 110 or attached to the outer surface of the light source body 110 with a conductive adhesive. The discharge voltage applying parts 130 includes a metal, for example, lead, copper, zinc, silver, tin, indium tin oxide or indium zinc oxide.

When one of the discharge voltage applying parts 130 receives a discharge voltage for negative polarity, a dielectric polarization occurs in the light source body 110 and electrons are collected in the light source body 110. When the other discharge voltage applying part 130 receives a discharge voltage for positive polarity while the electrons are collected in the light source body 110, the electrons easily move to the other discharge voltage applying part 130 having the discharge voltage for positive polarity. Thus, the surface light source device 100 causes the discharging in the light source body 110 with lower discharge voltage, and decreases power consumption thereof. Further, since the discharge gas is received and uniformly distributed in the at least two discharge spaces 117, the surface light source device 100 emits the light having a uniformed brightness and a higher brightness.

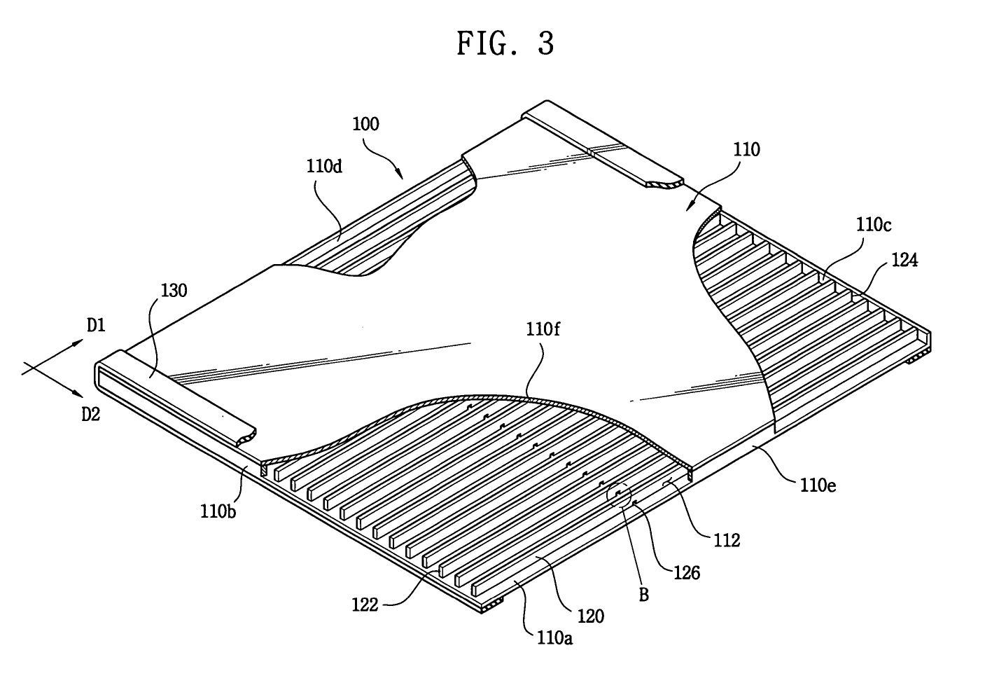

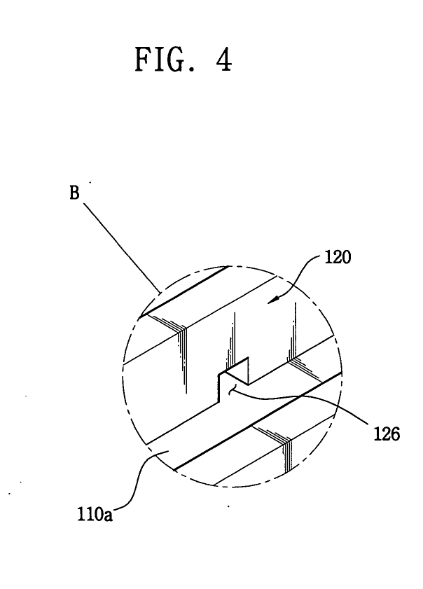

FIG. 3 is a perspective view showing a surface light source device according to another exemplary embodiment of the present invention. FIG. 4 is an enlarged view showing a portion “B” of FIG. 3. In FIGS. 3 and 4, the same reference numerals denote the same elements in FIGS. 1 and 2, and thus the detailed descriptions of the same elements will be omitted.

Referring to FIGS. 2-4, a space-dividing wall 120 includes at least one thru-hole 126 for supplying a discharge gas 114 into to discharge spaces 117 until the discharge gas 114 has a uniformed pressure distribution in the discharge spaces 117. Thus, the surface light source device 100 emits the light having a uniformed brightness from the discharge spaces 117.

The thru-hole 126 is formed at a lower portion of the space-dividing wall 120, for example a portion of the space-dividing wall 120 adjacent to the bottom surface 110a of the light source body 110. Because the brightness uniformity of the light emitted from the surface light source device 100 depends on the uniformity of the pressure distribution of the discharge gas 114 in the discharge spaces 117, it is important where the true-hole 126 is disposed on the space-dividing wall 120. For example, when the thru-hole 126 formed at the space-dividing wall 120 is overlapped with the discharge voltage applying parts 130, the discharge gas 114 may be not uniformly distributed in the discharge spaces 117 due to the deterioration of the electrical property of the discharge gas 114 adjacent to the thru-hole 126.

Particularly, the discharge gas 114 may have different plasma density between the discharge spaces 117 adjacent to the thru-hole 126, and thus the discharge gas 114 may move between the discharge spaces 117. As a result, the brightness at the discharge space having an amount of discharge gas more than a predetermined amount of discharge gas increases, and the brightness at a discharge space having an amount of discharge gas less than the predetermined amount of discharge gas decreases.

Thus, in order to improve the brightness uniformity between the discharge spaces 117, the thru-hole 126 is formed at a position of the space-dividing wall 120 not overlapped with the discharge voltage applying parts 130. For example, the thru-hole 126 is formed at a middle portion of the first and second ends 122 and 124 of the space-dividing wall 120. Thus, the surface light source device 100 improves the distribution uniformity of the discharge gas 114 in the discharge space 117 as well as the brightness uniformity of the light emitted from the surface light source device 100 by controlling the position of the true-hole 126 at the space-dividing wall 120.

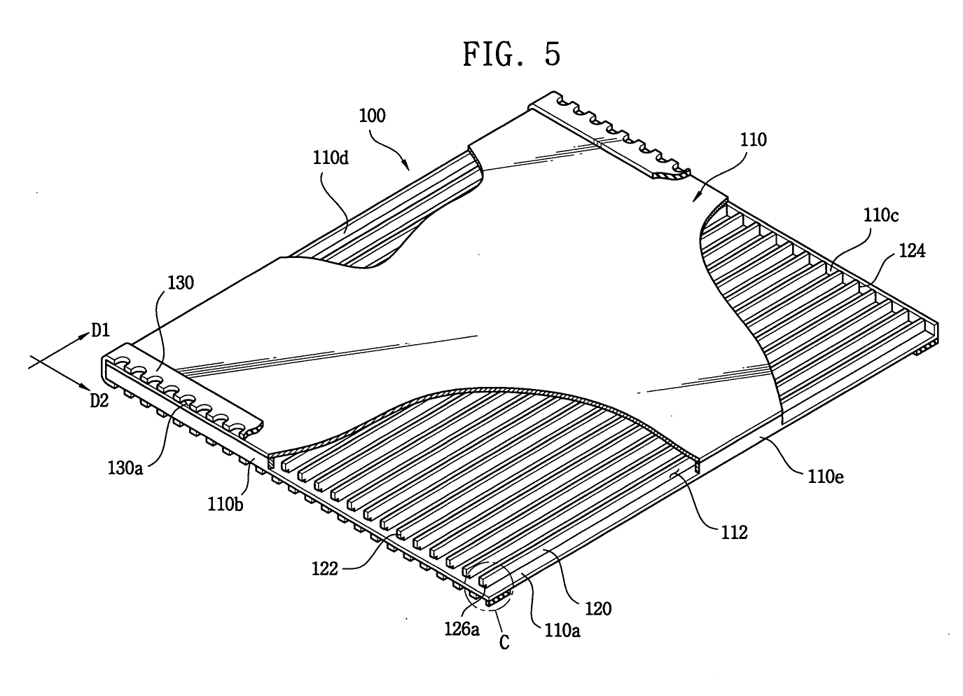

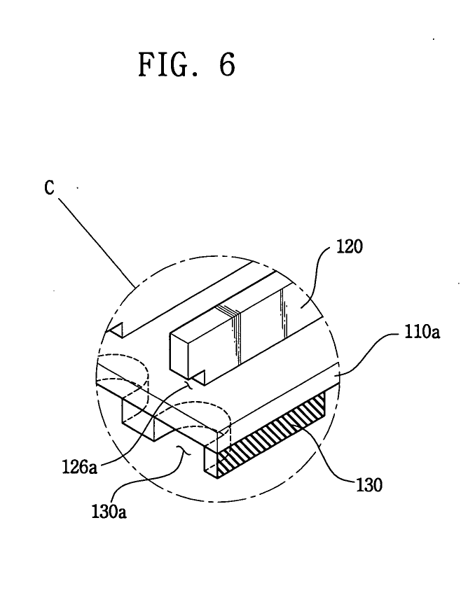

FIG. 5 is a perspective view showing a surface light source device according to another exemplary embodiment of the present invention. FIG. 6 is an enlarged view showing a portion “C” of FIG. 5. In FIGS. 5 and 6, the same reference numerals denote the same elements in FIG. 3, and thus the detailed descriptions of the same elements will be omitted.

Referring to FIGS. 2, 5 and 6, a space-dividing wall 120 includes at least one thru-hole 126a formed at a portion contacting with a first or second sidewall 110b or 110c of a light source body 110. For example, the thru-hole 126a is formed at a first end 122 of the space-dividing wall 120 making contact with the first sidewall 110b of the light source body 110 or a second end 124 of the space-dividing wall 120 making contact with the second sidewall 110c of the light source body 110. FIG. 5 shows the thru-hole 126a formed at the first end 122 of the space-dividing wall 120 making contact with the first sidewall 110b of the light source body 110.

Because the thru-hole 126a is formed at the end 122 or 124 of the space-dividing wall 120 making contact with the first or second sidewall 110b or 110c where each of discharge voltage applying parts 130 is disposed, a discharge gas 114 may be not uniformly distributed in discharge spaces 117 due to the overlapping of the discharge voltage applying parts 130 and the true-hole 126a and the movement of the discharge gas 114 between the discharge spaces 117 at the overlapped portion. In order to uniformly distribute the discharge gas 114 in the discharge spaces 117 and prevent the deterioration of the brightness uniformity of the light even at the overlapped portion, a cut-away portion 130a is formed at a certain portion of the discharge voltage applying parts 130, wherein the discharge voltage applying parts 130 are overlapped with the true-hole 126a. Since the certain portion overlapping with the true-hole 126a is cut away from the discharge voltage applying parts 130, the discharging is not occurred at the overlapped portion and the discharge gas 114 is uniformly distributed in the discharge spaces 117 without the movement of the discharge gas 114 due to the plasma density difference between the discharge gas 114. The cut-away portion 130a has a small area enough for maintaining the brightness uniformity of the light, while preventing the discharging at the overlapped area, and has, for example, a hemi-spherical shape.

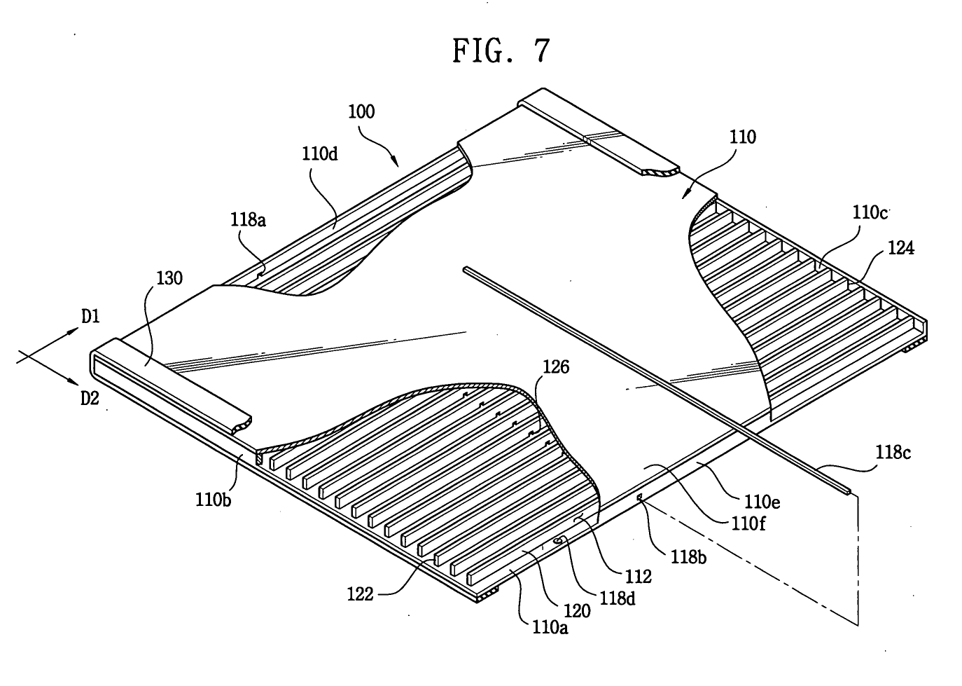

FIG. 7 is a partially exploded perspective view showing a surface light source device according to another exemplary embodiment of the present invention. In FIG. 7, the same reference numerals denote the same elements in FIG. 3, and thus the detailed descriptions of the same elements will be omitted.

Referring to FIGS. 2 and 7, a light source body 110 further includes a discharge gas port 118d formed through a bottom surface 110a, first and second sidewall thru-holes 118a and 118b each formed at third and fourth sidewalls 110d and 110e and a sealing bar 118c inserted in a thru-hole 126 and the first and second sidewall thru-holes 118a and 118b.

The discharge gas port 118d decompresses the inside of the light source body 110 before supplying a discharge gas 114 into the light source body 110. The first and second sidewall thru-holes 118a and 118b are arranged at the third and fourth sidewalls 110d and 110e such that the first and second sidewall thru-holes 118a and 118b and the thru-hole 126 (which is formed at a space-dividing wall 120) are positioned in a straight line.

The sealing bar 118c is inserted into the first and second sidewall thru-holes 118a and 118b and the thru-hole 126 to seal the holes 118a, 118b and 126, after the discharge gas 114 is injected into discharge spaces 117 of the light source body 110. The sealing bar 118c includes a transparent material, and has a length equal to a distance between the third and fourth sidewalls 110d and 110e. Since the sealing bar 118c prevents the movement of the discharge gas 114 between adjacent discharge spaces 117 through the holes after supplying the discharge gas 114 into the discharge spaces 117, the uniformity of the pressure distribution of the discharge gas 114 in the discharge spaces 117 is further improved. Thus, the light source body 110 further improves the brightness uniformity of the light emitted from the discharge spaces 117.

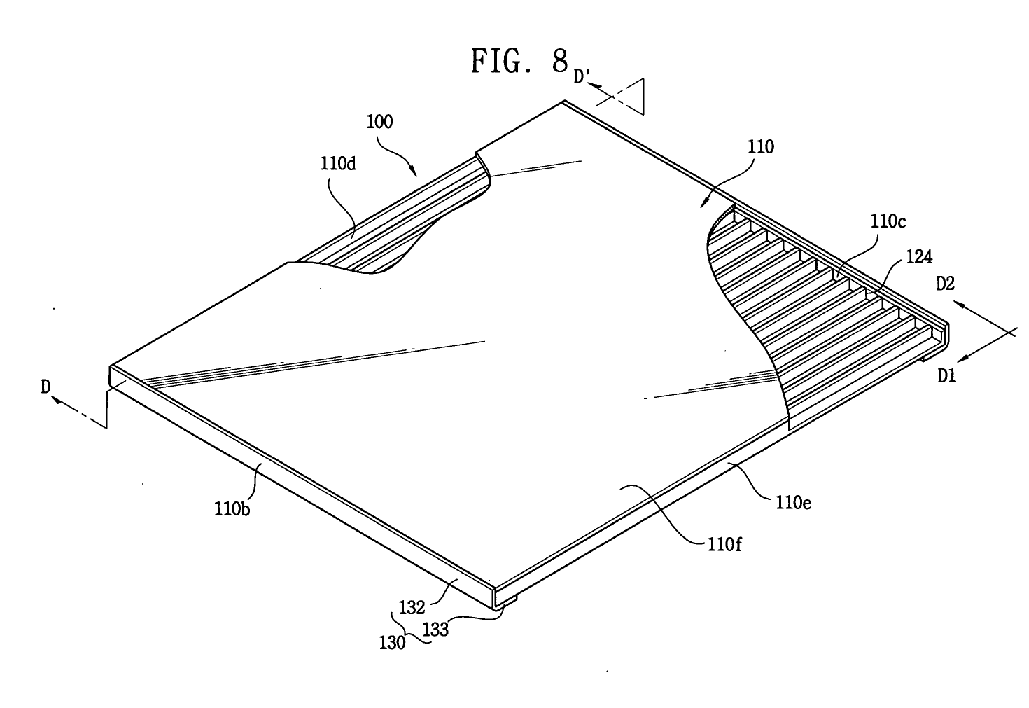

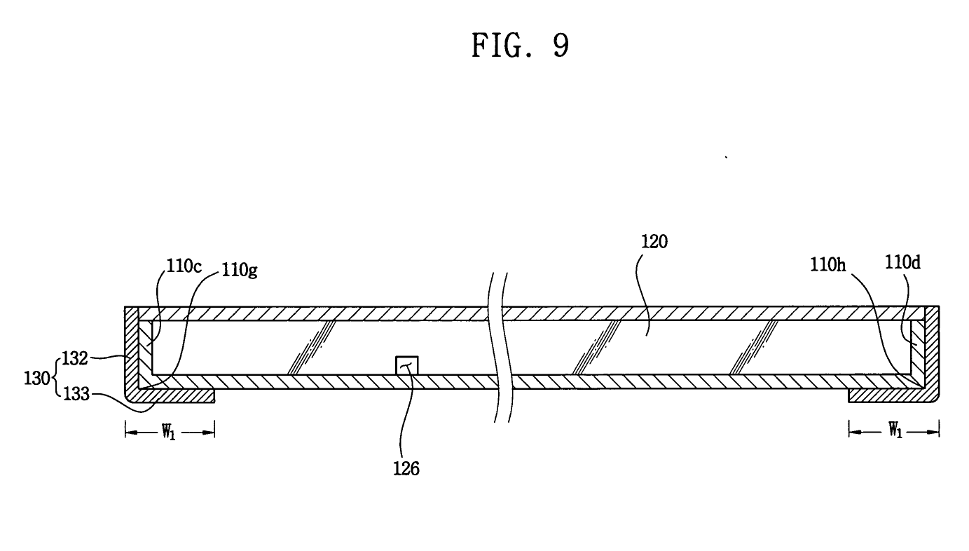

FIG. 8 is a perspective view showing a surface light source device according to another exemplary embodiment of the present invention. FIG. 9 is a cross-sectional view taken along the line D-D′ of FIG. 8. In FIGS. 8 and 9, the same reference numerals denote the same elements in FIG. 1, and thus the detailed descriptions of the same elements will be omitted.

Referring to FIGS. 8 and 9, each of discharge voltage applying parts 130 includes a first conductive member 132 and a second conductive member 133. The first conductive member 132 is disposed over a first sidewall 110b or a second sidewall 110c opposite to the first sidewall 110b of a light source body 110. The second conductive member 133 is extended from the first conductive member 132 toward an outer surface of a bottom surface 110a of the light source body 110 in a predetermined width W1. Thus, the second conductive member 133 is disposed on the outer surface of the bottom surface 110a. Particularly, the second conductive member 133 is extended from a first corner 110g where the first sidewall 10b meets the bottom surface 110a or from a second corner 110h where the second sidewall 110c meets the bottom surface 110a, toward the outer surface of the bottom surface 110a, in the predetermined width W1. Since each of the discharge voltage applying parts 130 is disposed on the light source body 110 to surround the first or second sidewall 110b or 110c and the bottom surface 110a, the light source body 110 exits a light through a light exit surface 110f thereof without a loss of the light at the light exit surface 119f.

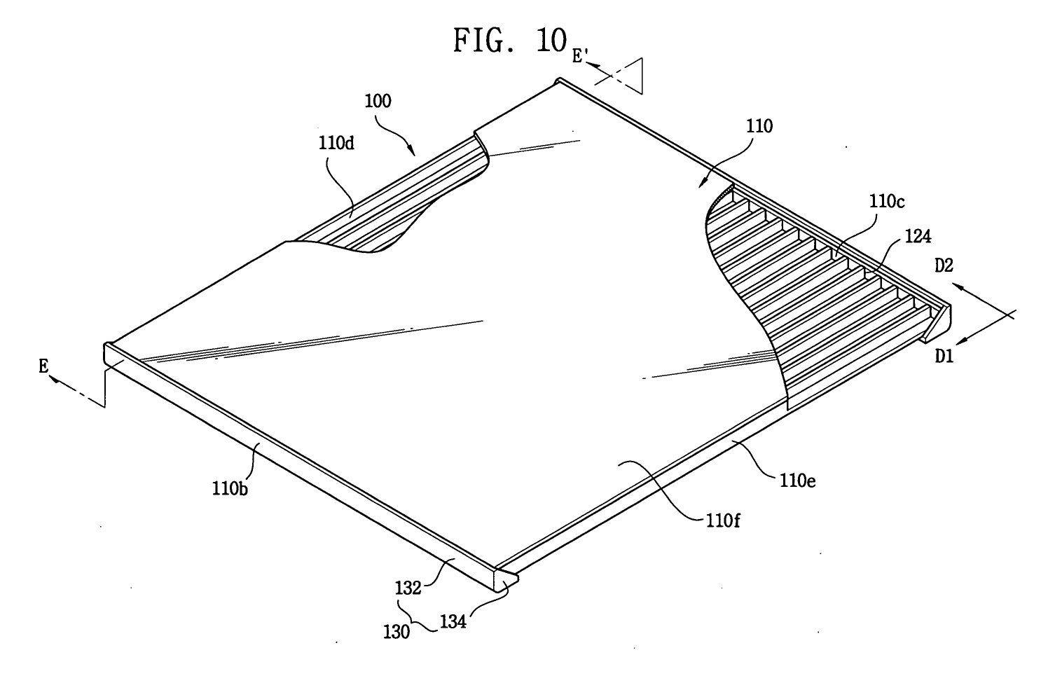

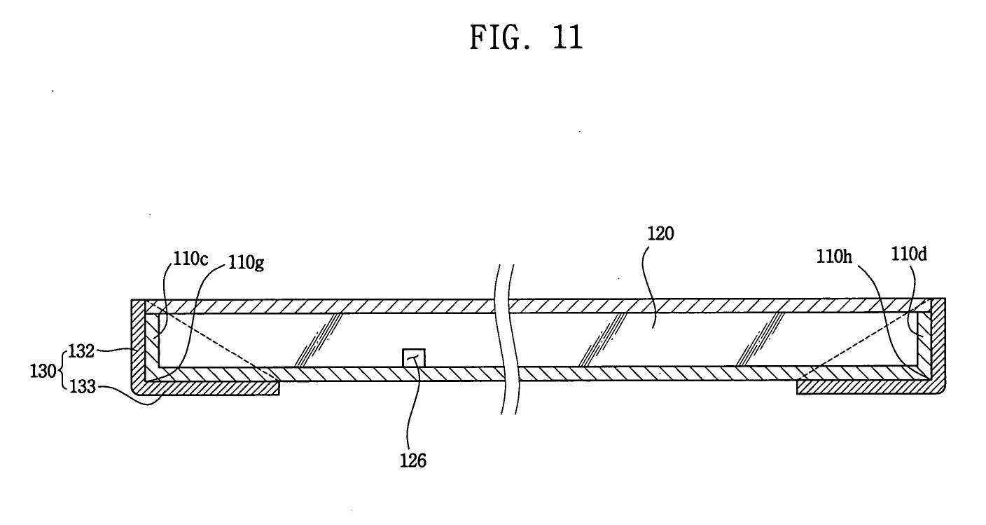

FIG. 10 is a perspective view showing a surface light source device according to another exemplary embodiment of the present invention. FIG. 11 is a cross-sectional view taken along the line E-E′ of FIG. 10. In FIGS. 10 and 11, the same reference numerals denote the same elements in FIGS. 8 and 9, and thus the detailed descriptions of the same elements will be omitted.

Referring to FIGS. 10 and 11, each of discharge voltage applying parts 130 includes a first conductive member 132, a second conductive member 133 and a third conductive member 134. The first and second conductive members 132 and 133 are formed as shown in FIGS. 8 and 9. The third conductive member 134 is extended from both ends of the first conductive member 132 or both ends of the second conductive member 133, toward a third sidewall 110d and a fourth sidewall 110e opposite to the third sidewall 110d. Also, the third conductive member 134 may be extended from both ends of the first and second conductive members 132 and 133, toward the third and fourth sidewalls 110d and 110e. Since the discharge voltage applying parts 130 includes the first to third conductive members 132, 133 and 134, the area of the discharge voltage applying parts 130 is enlarged, thereby improving brightness of the light exited through a light exit surface 110f.

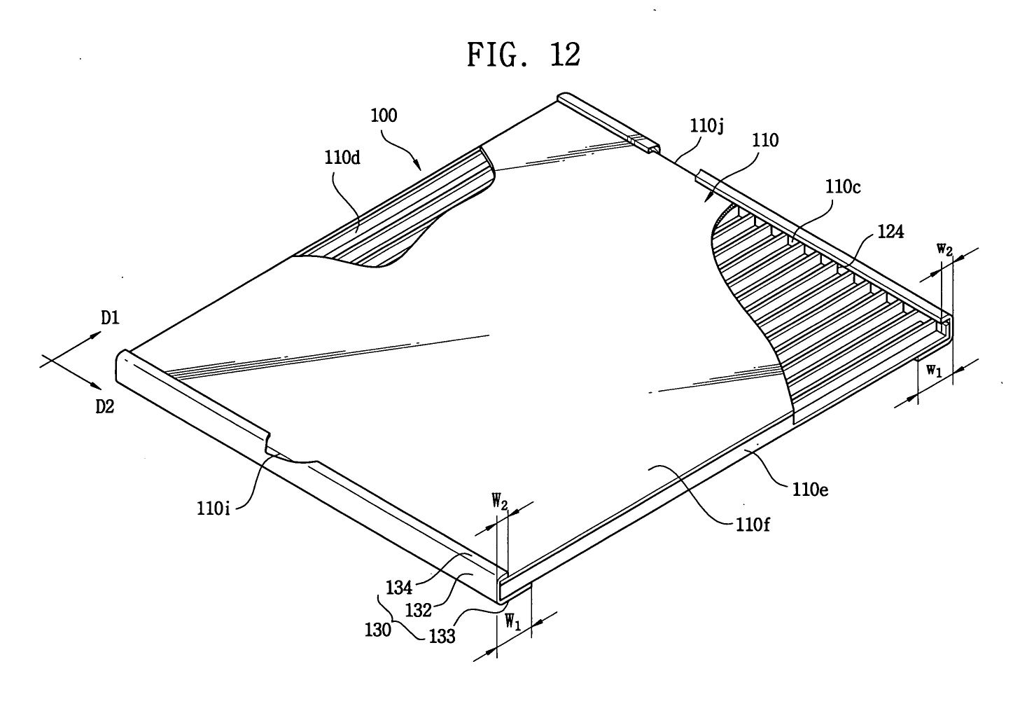

FIG. 12 is a perspective view showing a surface light source device according to another exemplary embodiment of the present invention. In FIG. 12, the same reference numerals denote the same elements in FIGS. 8 and 9, and thus the detailed descriptions of the same elements will be omitted.

Referring to FIG. 12, each of discharge voltage applying parts 130 includes a first conductive member 132, a second conductive member 133 and a third conductive member 134. The first and second conductive members 132 and 133 are formed as shown in FIGS. 8 and 9. The third conductive member 134 is extended from the first conductive member 132 toward a light exit surface 110f of a light source body 110. Particularly, the third conductive member 134 is extended from a third corner 110i where the first sidewall 110b meets the light exit surface 110f or from a fourth corner 110j where the second sidewall 110c meets the light exit surface 110f, toward the light exit surface 110f, in a predetermined width W2. In order to prevent reduction of an amount of a light exited through the light exit surface 110f while increasing the entire area of the light exit surface 110f, the extended width W2 of the third conductive member 134 is determined to be narrower than the extended width W1 of the second conductive member 133.

Since the discharge voltage applying parts 130 includes the third conductive member 134 integrally formed with the first conductive member 132 and disposed on the light exit surface 110f, a surface area of the discharge voltage applying part 130 is enlarged. Also, the extended width W2 of the third conductive member 134 is narrower than the extended width W1 of the second conductive member 133, and thus the amount of the light exited through the light exit surface 110f is not reduced.

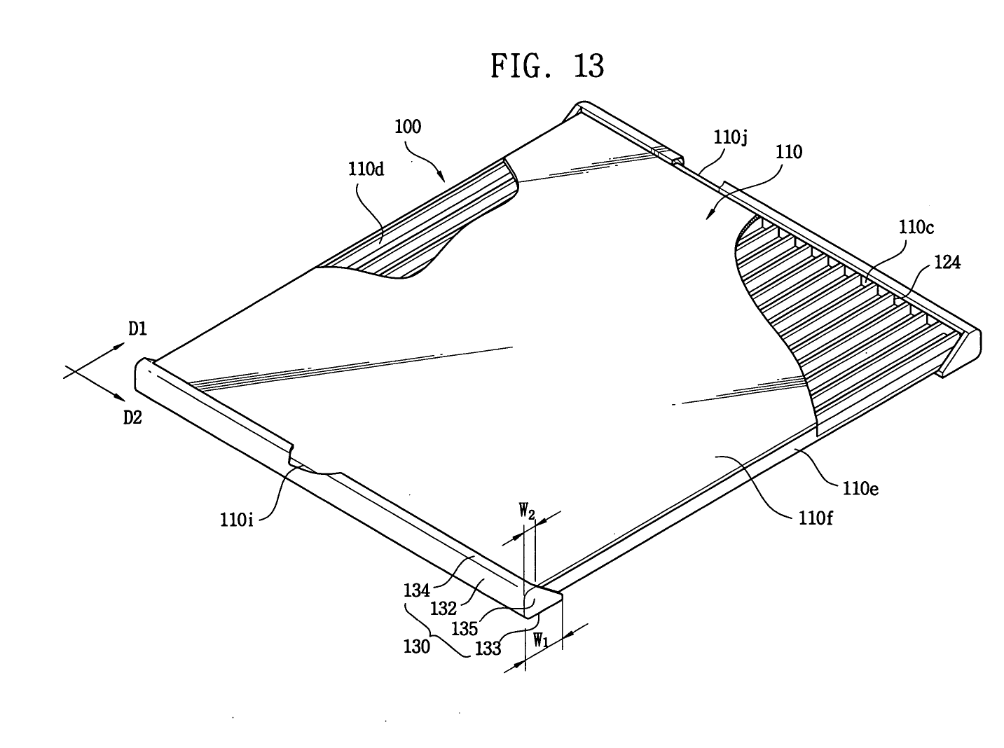

FIG. 13 is a perspective view showing a surface light source device according to another exemplary embodiment of the present invention. In FIG. 13, the same reference numerals denote the same elements in FIG. 12, and thus the detailed descriptions of the same elements will be omitted.

Referring to FIG. 13, each of discharge voltage applying parts 130 includes a first conductive member 132, a second conductive member 133, a third conductive member 134 and a fourth conductive member 135. The first, second and third conductive members 132, 133 and 134 are formed as shown in FIG. 12. The fourth conductive member 135 is integrally formed with the first, second and third conductive members 132, 133 and 134, and extended from both ends of the first conductive member 132 or both ends of the second conductive member 133, toward a third sidewall 110d and a fourth sidewall hoe opposite to the third sidewall 110d. Also, the fourth conductive member 135 may be extended from both ends of the first and second conductive members 132 and 133, toward the third and fourth sidewalls 110d and 110e. FIG. 13 shows the fourth conductive member 135 extended from both ends of the first conductive member 132 toward the third and fourth sidewalls hod and 110e. Thus, the discharge voltage applying parts 130 have a further enlarged area and the brightness of a surface light source device 100 is further improved.

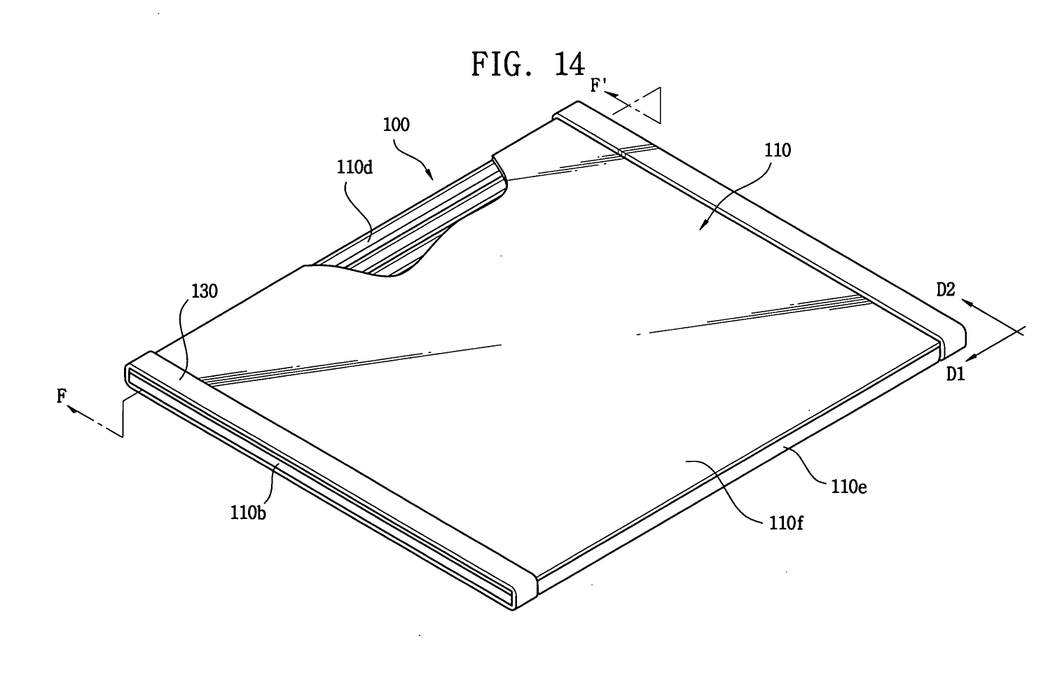

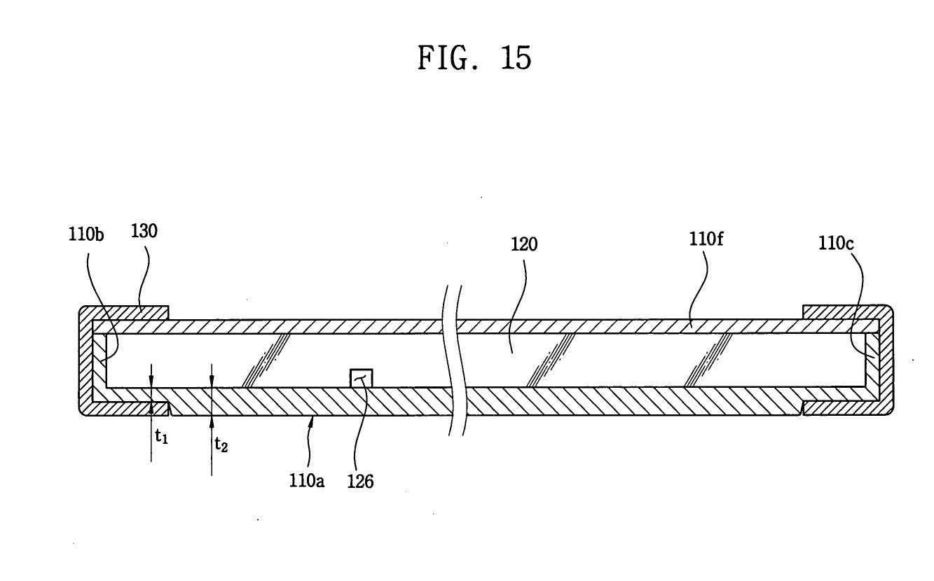

FIG. 14 is perspective view showing a surface light source device according to another exemplary embodiment of the present invention. FIG. 15 is a cross-sectional view taken along the ling F-F′ of FIG. 14. In FIGS. 14 and 15, the same reference numerals denote the same elements in FIGS. 1 and 2, and thus the detailed descriptions of the same elements will be omitted.

When a space-dividing wall 120 and first to fourth sidewalls 110b-110e are formed with different materials from that of a bottom surface 110a, a deformation or twist may be occurred between the space-dividing wall 120 and first to fourth sidewalls 110b-110e, and the bottom surface 110a during a firing process due to the their thermal expansion coefficient difference.

In order to prevent the deformation or twist, as shown in FIGS. 14 and 15, the bottom surface 110a may have a thickness thicker than that of a light exit surface 110f. For example, when the light exit surface 110f has a thickness of about 1 mm, the bottom surface 110a has a thickness of about 3 mm. Thus, the light source body 110 prevents the deformation or twist of the bottom surface 110a, first to fourth sidewalls 110b, 110c, 110d and 110e and space-dividing wall 120 during the firing process.

However, when the thickness of the bottom surface 110a is thicker than the thickness of the light exit surface 110f, the discharge voltage applying parts 130 may have decreased capacitance and require increased driving voltage, resulting in increasing of power consumption of the surface light source device 100. Thus, a portion of the bottom surface 110a, which corresponds to the discharge voltage applying parts 130, has a thickness substantially equal to that of the light exit surface 110f. Particularly, a portion of the bottom surface 110a, which makes contact with the discharge voltage applying parts 130, has a first thickness t1 substantially equal to that of the light exit surface 110f, and a remaining portion of the bottom surface 110a, which does not make contact with the discharge voltage applying parts 130, has a second thickness t2 greater than the first thickness t1. For example, when the first thickness t1 is about 1 mm, the second thickness t2 is about 3 mm. Thus, the surface light source device 100 decrease the driving voltage and power consumption while preventing the deformation or twist of the bottom surface 110a.

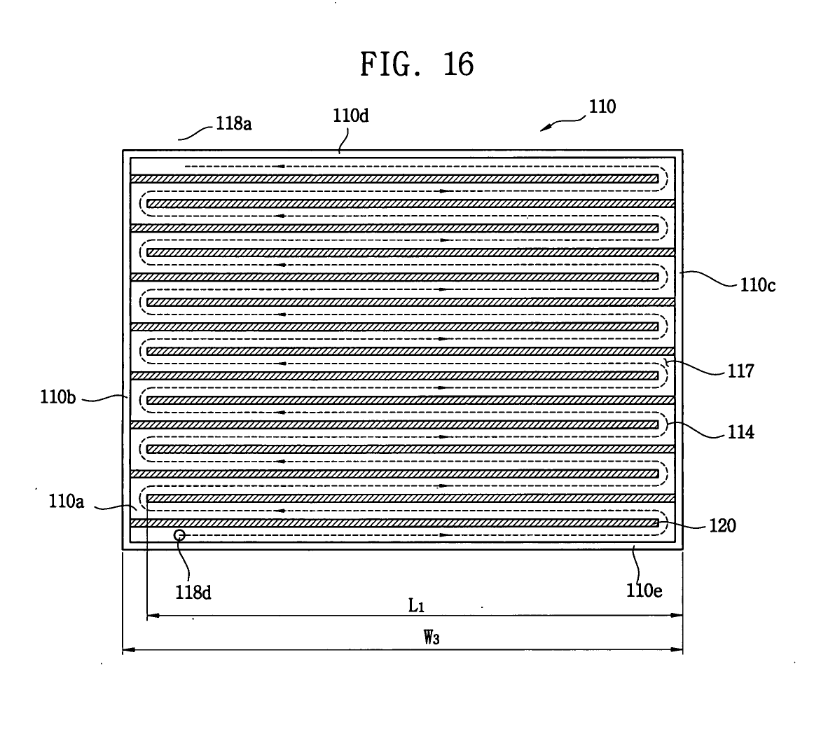

FIG. 16 is a schematic view showing a surface light source according to another exemplary embodiment of the present invention. In FIG. 16, the same reference numerals denote the same elements in FIGS. 2 and 7, and thus the detailed descriptions of the same elements will be omitted.

Referring to FIG. 16, a space-dividing wall 120 is disposed in a direction substantially perpendicular to first and second sidewalls 110b and 110c in a light source body 110. The space-dividing wall 120 has a length L1 less than a width W3 between the first and second sidewalls 110b and 110c. A plurality of space-dividing walls is arranged in the light source body 110 with alternately coupling the first and second sidewalls 110b and 110c. Thus, when a discharge gas 114 is provided to via one of discharge gas ports 118d formed through the light source body 110, the discharge gas 114 is distributed into discharge spaces 117, along a passage formed between the space-dividing walls and the first and second sidewalls 110b and 110c. Accordingly, the discharge gas 114 is uniformly provided into the discharge spaces 117 defined by the space-dividing walls, and the brightness uniformity of the light is improved at the discharge spaces 117.

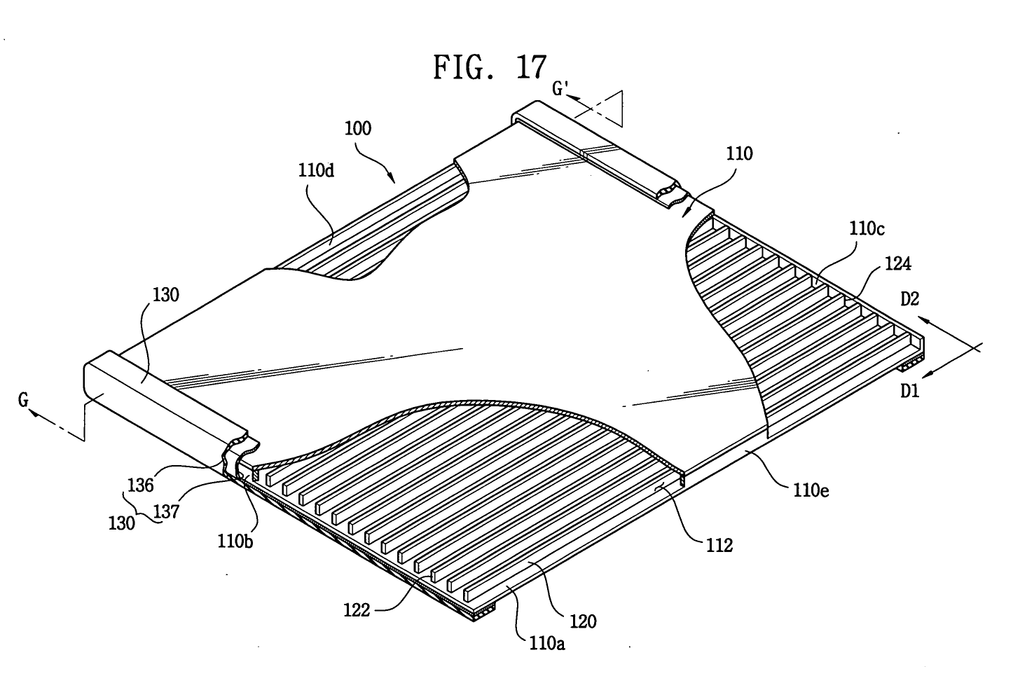

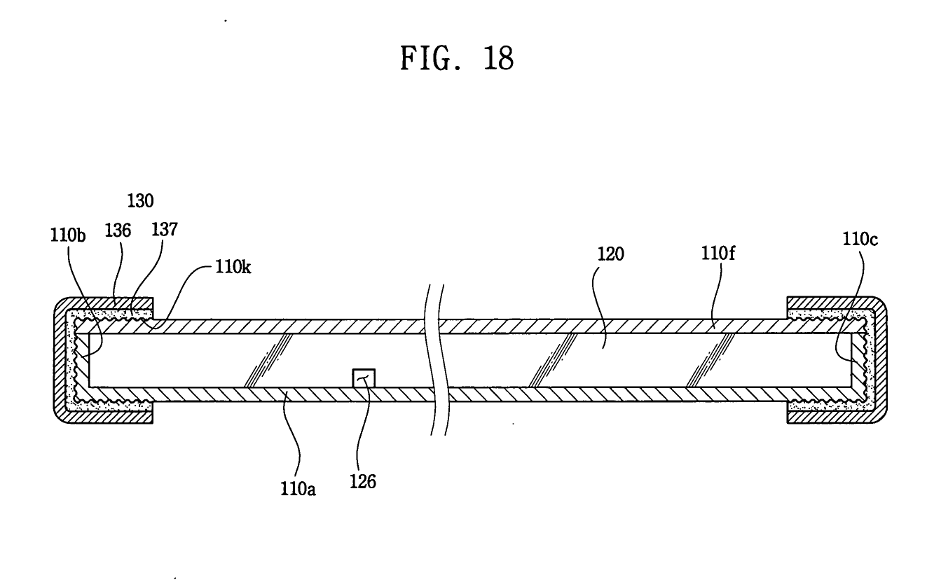

FIG. 17 is a perspective view showing a surface light source device according to another exemplary embodiment of the present invention. FIG. 18 is a cross-sectional view taken along the line G-G′ of FIG. 17. In FIGS. 17 and 18, the same reference numerals denote the same elements in FIGS. 1 and 2, and thus the detailed descriptions of the same elements will be omitted.

Referring to FIGS. 17 and 18, each of a pair of discharge voltage parts 130 includes a first discharge voltage applying part 136 coupled to one end of a light source body 110 and a second discharge voltage applying part 137 disposed between the light source body 110 and the first discharge voltage applying part 136. The first discharge voltage applying part 136, for example, is coupled to the light source body 110 to cap one end of the light source body 110. The second discharge voltage applying part 137 is melted between the light source body 110 and the first discharge voltage applying part 136 so as to fix the first discharge voltage applying part 136 to the light source body 110. Thus, the second discharge voltage applying part 137 prevents the separation of the first discharge voltage applying part 136 and the light source body 110 and electrically connects the first discharge voltage applying part 136 and the light source body 110.

The first discharge voltage applying part 136 has, for example, a thickness from about 0.5 to about 1.0 mm, and the second discharge voltage applying part 137 has a thickness less than that of the first discharge voltage applying part 136. The first discharge voltage applying part 136 prevents the deviation of the second discharge voltage applying part 137 from the light source body 110 due to a corona discharge. The first discharge voltage applying part 136 includes, for example, a lead, copper, zinc, silver or tin, indium tin oxide or indium zinc oxide, and the second discharge voltage applying part 137 includes, for example, a conductive paste which connects the first discharge voltage applying part 136 and the light source body 110. The conductive paste may include a metal particle such as Ni or Au scattered on an adhesive material.

The light source body 110 further includes an attaching portion 110k on the outer surface thereof, in which the second discharge voltage applying part 137 is disposed. Since the attaching portion 110k has, for example, a plurality of protrusion portions, the surface roughness of the attaching portion is greater than that of the remaining portions of the outer surface of the light source body 110. Further, the surface area of the attaching portion 110k is greater than the remaining portions of the outer surface of the light source body 110.

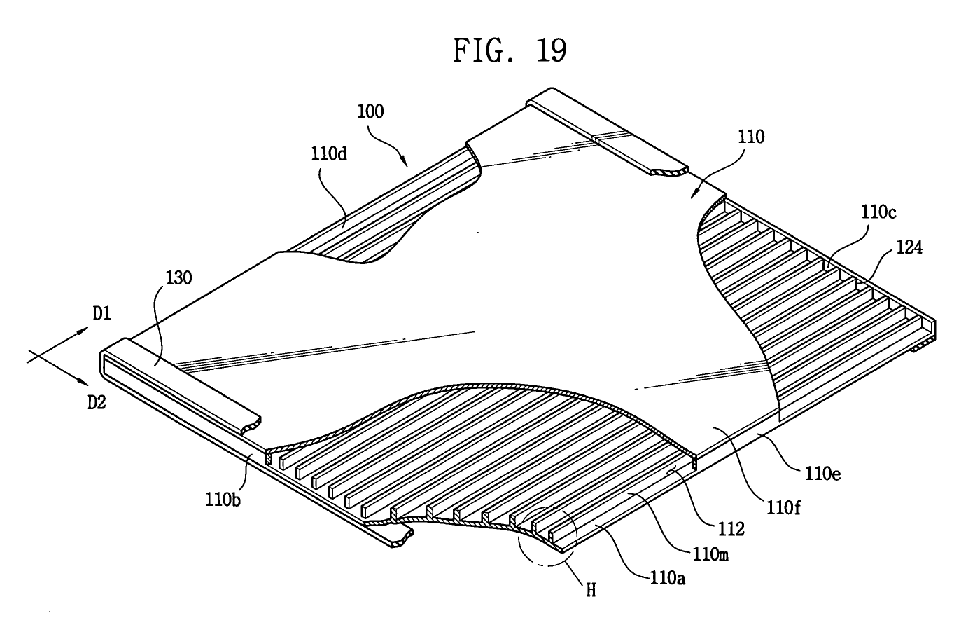

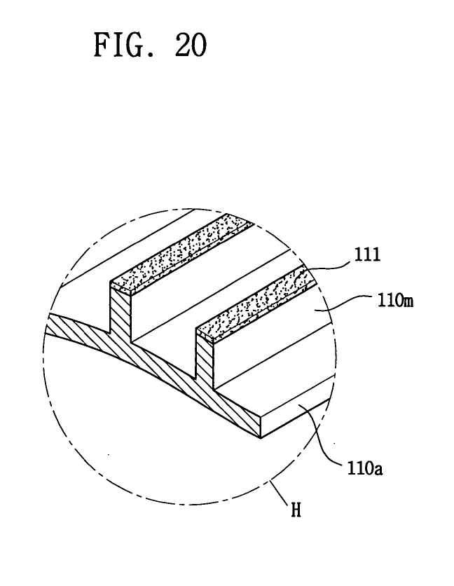

FIG. 19 is a perspective view showing a surface light source device according to another exemplary embodiment of the present invention. FIG. 20 is an enlarged view showing a portion “H” of FIG. 19. In FIGS. 19 and 20, the same reference numerals denote the same elements in FIGS. 1 and 2, and thus the detailed descriptions of the same elements will be omitted.

Referring to FIGS. 19 and 20, a light source body 110 includes at least one space-dividing portion 110m integrally formed with a bottom surface 110a, and prevents the bend or deformation between the bottom surface 110a and the space-dividing portion 110m. The space-dividing portion 110m is disposed in a direction substantially perpendicular to first and second sidewalls 110b and 110c of the light source body 110.

The space-dividing portion 110m includes an adhesive 111 formed on an upper surface thereof, which faces a light exit surface 110f of the light source body 110. The adhesive 111 may be removed when the space-dividing portion 110m and the upper surface are close enough to form a discharge space. In case that the upper surface of the space-dividing portion 110m does not directly make contact with the light exit surface 110f due to a processing error, the adhesive 111 seals a gap between the light exit surface 110f and the space-dividing portions 110m, and prevents flow of the discharge gas through the gap. The upper surface of the space-dividing portion 110m may be rounded so as to reduce an area that makes contact with the light exit surface 110f, thereby preventing the light from being intercepted by the space-dividing portion 110m and improving brightness of the light exited through the light exit surface 110f. Thus, the light source body prevents the bend or deformation of the bottom surface 110a and the space-dividing portion 110m as well as improves the brightness of the light exited through the light exit surface 110f.

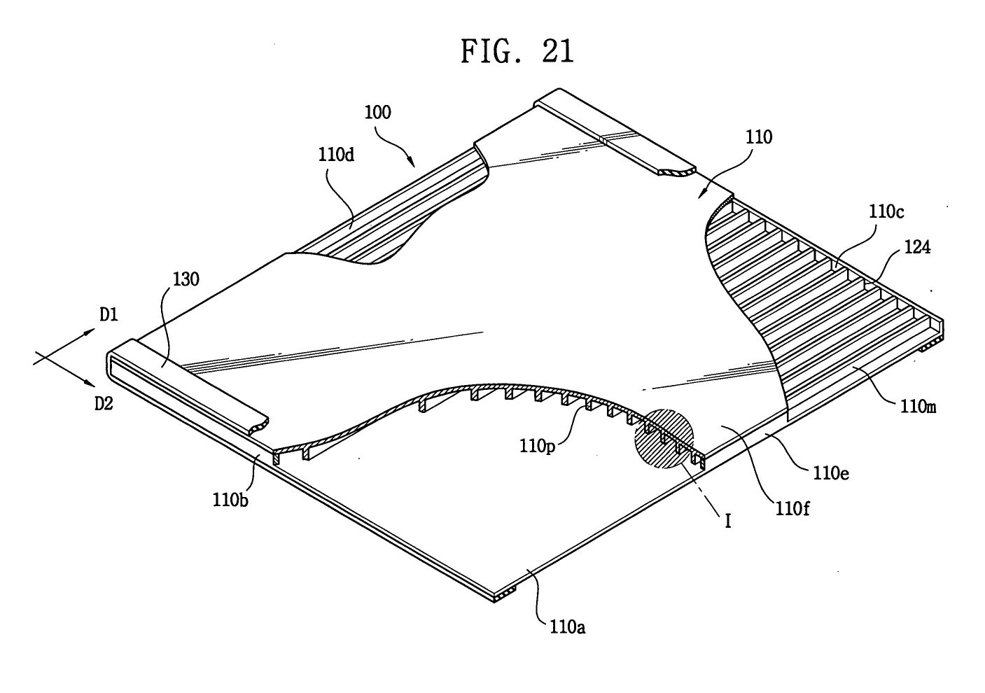

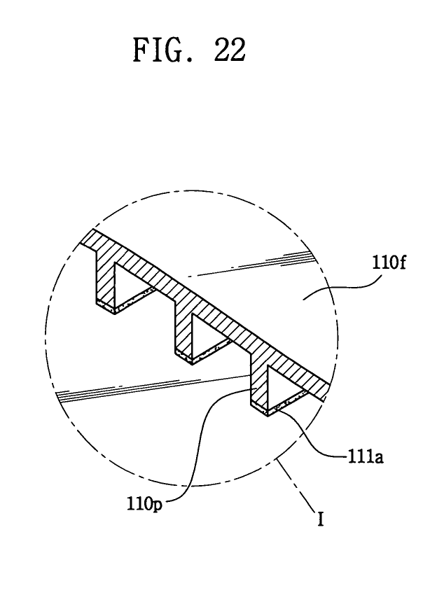

FIG. 21 is a perspective view showing a surface light source device according to another exemplary embodiment of the present invention. FIG. 22 is an enlarged view showing a portion ‘T’ of FIG. 21. In FIGS. 21 and 22, the same reference numerals denote the same elements in FIGS. 19 and 20, and thus the detailed descriptions of the same elements will be omitted.

Referring to FIGS. 21 and 22, a light source body 110 includes at least one space-dividing portion 110m integrally formed with a light exit surface 110f of a light source body 110. The space-dividing portion 110m is disposed in a direction substantially perpendicular to first and second sidewalls 110b and 110c of the light source body 110.

The space-dividing portion 110m includes an adhesive 111a formed on a lower surface thereof, which faces a bottom surface 110a of the light source body 110. The adhesive 111 may be removed when the space-dividing portion 110m and the lower surface are close enough to form a discharge space. In case that the lower surface of the space-dividing portion 110m does not directly make contact with the bottom surface 110a due to a processing error, the adhesive 111a seals a gap between the bottom surface 110a and the space-dividing portion 110m and prevents flow of the discharge gas through the gap.

The lower surface of the space-dividing portions 110m may be rounded so as to reduce an area that makes contact with the bottom surface 110a, thereby preventing the light from being intercepted by the space-dividing portion 110m and improving brightness of the light exited through the light exit surface 110f. Thus, the light source body 110 prevents the bend or deformation of the light source body 110 by employing the space-dividing portions 110m integrally formed with the light exit surface 110f thereof.

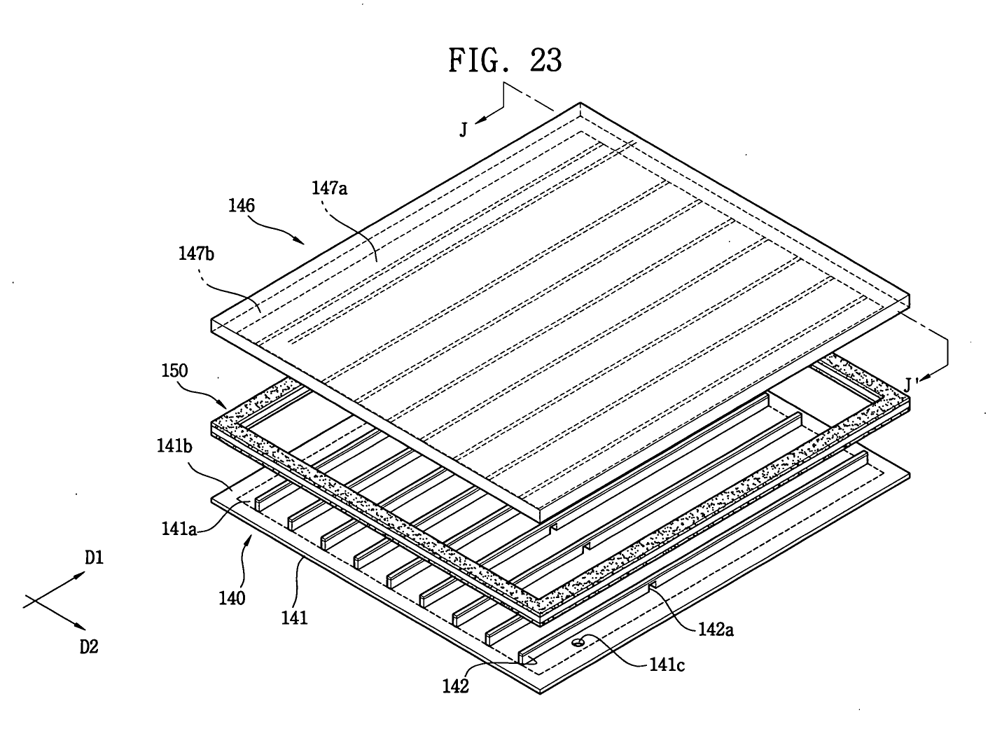

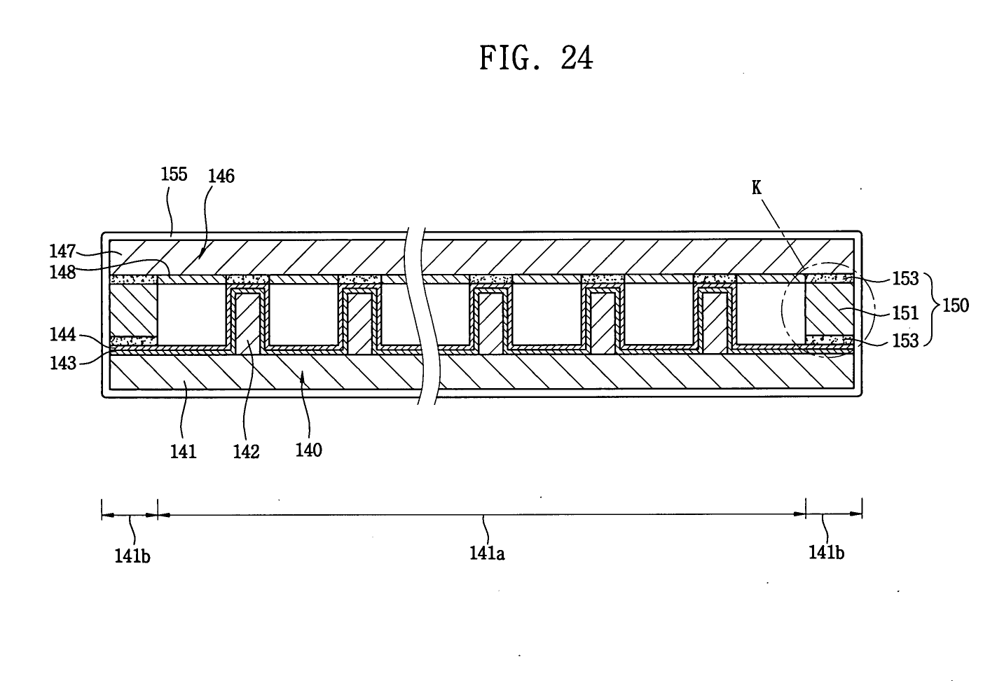

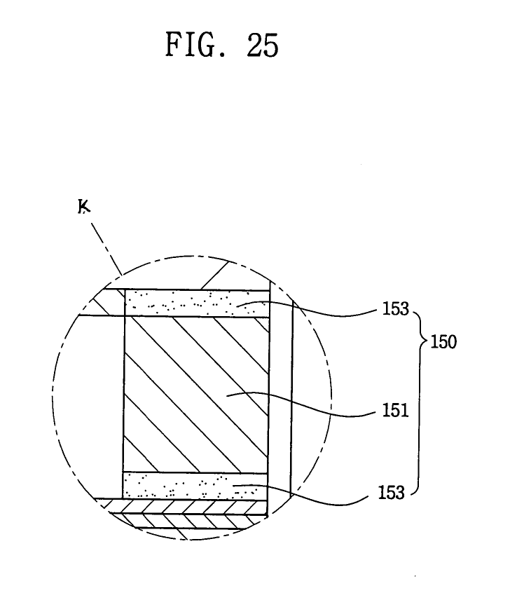

FIG. 23 is an exploded perspective view showing a surface light source device according to another exemplary embodiment of the present invention. FIG. 24 is a cross-sectional view taken along the line J-J′ of FIG. 23. FIG. 25 is an enlarged view showing a portion “K” of FIG. 24.

Referring to FIGS. 23 to 25, a surface light source device includes a first substrate 140, a second substrate 146, a sealing member 150 and at least one discharge voltage applying part 155. The first substrate 140 includes a first transparent substrate 141, at least one space-dividing wall 142, a light reflection layer 143 and a first fluorescent layer 144.

The first transparent substrate 141 includes, for example, a glass substrate of high light transmittance, and is flat and substantially rectangular. The first transparent substrate 141 includes a first light exiting area 141a and a first sealing area 141b. The first sealing area 141b is disposed at the edges of the first transparent substrate 141 such that the first sealing area 141b surrounds the first light exiting area 141a. A discharge gas port 141c is formed at the first light exiting area 141a through the first transparent substrate 141 such that the discharge gas port 141c is not overlapped with the space-dividing wall 142.

The space-dividing wall 142 is formed on the first light exiting area 141a and divides the first light exiting area 141a into at least two discharge spaces. For example, the space-dividing wall 142 is extended in a first direction D1 and arranged in a second direction D2, which is spaced apart from each other, as shown in FIG. 23. The space-dividing wall 142 supplies the discharge gas inputted through the discharge gas port 141c into the first substrate 140 through a thru-hole 142a formed through the space-dividing wall 142. Alternatively, when a plurality of space-dividing walls is alternately arranged at the first light exiting area 141a and forms a zigzag passage in the discharge spaces, the discharge gas is supplied into the discharge spaces through the passage. The space-dividing wall 142 includes a mortar material or a transparent material hardened through a firing process.

The light reflection layer 143 may be formed on the space-dividing wall 142 and the first light exiting area 141a or on the space-dividing wall 142, the first light exiting area 141a and the first sealing area 141b. The light reflection layer 143, for example, includes Al₂O₃ or TiO₃.

The first fluorescent layer 144 is formed on the light reflection layer 143. As shown in FIG. 24, the first fluorescent layer 144 is disposed on the first sealing area 141b, the first light exit area 141a and the space-dividing wall 142, on which the light reflection layer 143 is disposed. The first fluorescent layer 144 includes three fluorescent materials, for example, a red fluorescent material, a green fluorescent material and a blue fluorescent material. The red, green and blue fluorescent materials change an invisible ray into a visible ray having a red wavelength, a visible ray having a green wavelength and a visible ray having a blue wavelength, respectively. The red, green and blue visible rays have an amount of light substantially equal to each other. The first fluorescent layer 144 receives the invisible ray of the discharge gas and changes the received invisible ray into a white light.

The second substrate 146 includes a second transparent substrate 147 and a second fluorescent layer 148. The second transparent substrate 147 is flat and substantially rectangular, and includes a second light exiting area 147a and a second sealing area 147b. The second sealing area 147b is disposed at the edges of the second transparent substrate 147 such that the second sealing area 147b surrounds the second light exiting area 147a, and faces the first sealing area 141b. The second transparent substrate 147, for example, is a glass substrate having a high light transmittance.

The second fluorescent layer 148 is disposed at the second light exiting area 147a of the second transparent substrate 147. Alternatively, the second fluorescent layer, as shown in FIG. 24, may be disposed at the second light exiting area 147a of the second transparent substrate 147 except the areas on which the second transparent substrate 147 faces the space-dividing wall 142 of the first substrate 140. The second fluorescent layer 148 has the same configuration as that of the first fluorescent layer 144 described above.

The first and second substrates 140 and 146 are connected by the sealing member 150 disposed between them. The sealing member 150 includes a body 151 and a sealant 153. The body 151 has a rectangular-shaped frame and is disposed on the first sealing area 141b of the first transparent substrate 141 and on the second sealing area 147b of the second transparent substrate 147. The body 151 includes a material equal to those of the first and second substrates 140 and 146 and prevents leakage of the discharge gas injected into between the first and second substrates 140 and 146. The sealant 153 is formed on both ends of the body 151, where the first and second sealing area 141b and 147b face each other. Further, the sealant may be formed on the areas of the second transparent substrate 147 facing the space-dividing wall 142. Thus, the first and second substrates 140 and 146 are coupled to each other by the sealing member 150 disposed on the first and second sealing areas 141b and 147b of the first and second substrates 140 and 146, and on the second transparent substrate 147 facing the space-dividing wall 142, through a firing process.

The discharge gas is supplied to between the first and second substrates 140 and 146 through the discharge gas port 141c formed at the first transparent substrate 141 of the first substrate 140. The discharge gas is uniformly supplied to the discharge spaces through the thru-hole 142a formed at the space-dividing wall 142. The discharge gas is injected into the discharge spaces after the pressure of the discharge spaces between the first and second substrates 140 and 146 is decompressed.

A pair of discharge voltage applying parts 155 is outwardly disposed on the first and second substrates 140 and 146 so as to cause the discharging in the discharge spaces. The discharge voltage applying parts 155 are arranged in the direction D2 substantially perpendicular to a longitudinal direction of the space-dividing wall 142. The discharge voltage applying parts 155, for example, include a band shape to outwardly surround the first and second substrates 140 and 146. The discharge voltage applying parts 155, for example, are attached on the outer surfaces of the first and second substrates 140 and 146 with a conductive adhesive. The discharge voltage applying parts 155 include, for example, lead, copper, zinc, silver, tin, indium tin oxide or indium zinc oxide.

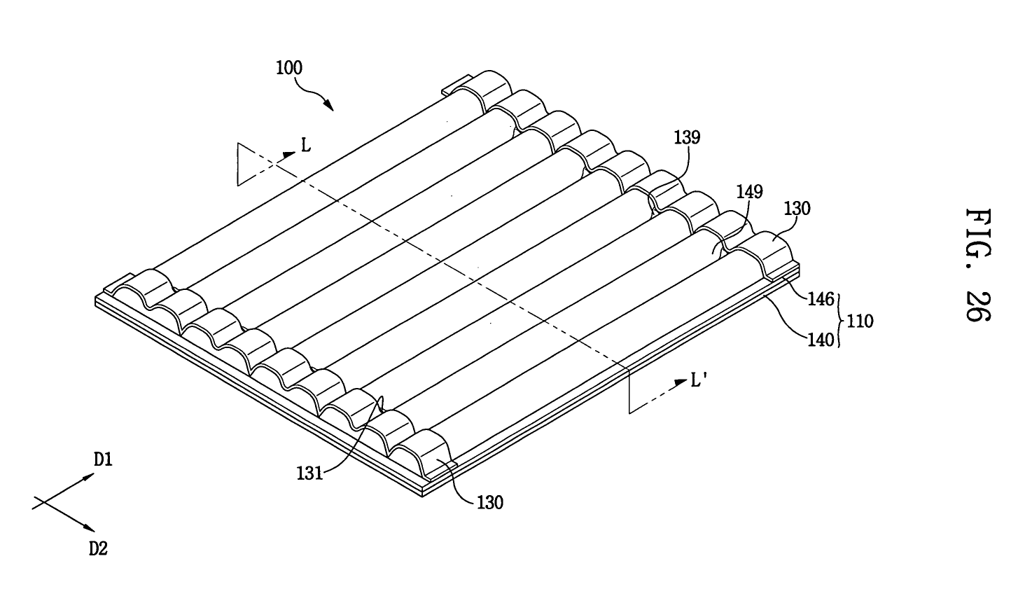

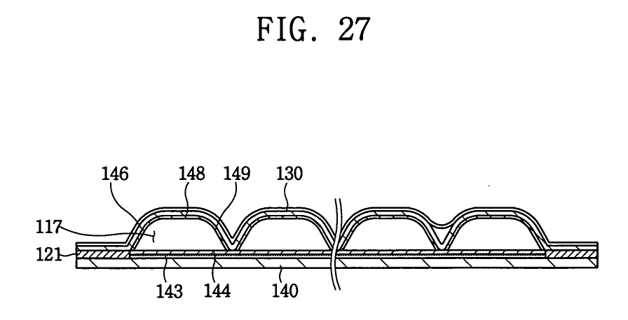

FIGS. 26 and 27 show a light source body according to another exemplary embodiment of the present invention. In FIGS. 26 and 27, the same reference numerals denote the same elements in FIGS. 23 to 25, and thus the detailed descriptions of the same elements will be omitted. Referring to FIGS. 26 and 27, a surface light source device 100 includes a light source body 110 having first and second substrates 140 and 146 and a pair of discharge voltage applying parts 130 disposed on the outer surface of the light source body 110. The first substrate 140 has a rectangular plate shape, and is connected with the second substrate 146. The first or second substrate 140 or 146 includes, for example, a glass substrate.

The second substrate 146 has at least two protrusions 149 arranged with spaces and in parallel to each other. The protrusions 149 extend in a longitudinal direction D1 of the second substrate 146, and have a predetermined height with respect to a bottom of the second substrate 146. The edges of first and second substrates 140 and 146 are connected to each other with an adhesive 121. For example, the adhesive 121 is placed and fired at the edges between the first and second substrates 140 and 146. At the same time, the protrusions 149 are closely adhered to each other by the press differences between the first and second substrates 140 and 146. The adhesive 121 includes, for example, a melted lead-glass. Since the first and second substrates 140 and 146 are connected at their edges, inner surfaces of the protrusions 149 face an inner surface of the first substrate 140 and the spaces between the first and second substrates 140 and 146 are divided into at least two discharge spaces 117 by the at least two protrusions 149.

The second substrate 146 may be manufactured with a forming. For example, the forming includes heating a glass substrate having a rectangular shape and reducing the hardness of the glass substrate; and molding the grass substrate in a desired shape to form the second substrate 146. The protrusions 149 of the second substrate 146 includes, for example, a trapezoid shape, an arched shape, a hemisphere shaped or a rectangular shape.

The pair of the discharge voltage applying parts 130 is arranged in an opposite direction D2 to the longitudinal direction of the second substrate 146, and includes a metal, for example, Cu, Ni, Al tape or Ag paste. Because the second substrate 146 has the protrusions 149, the discharge voltage applying parts 130 has a shape similar to the shape of the protrusions 149.

A discharge gas for example, mercury (Hg), an argon gas, a neon gas, a xenon gas or a krypton gas in individual or in combination is inserted in the discharge spaces 117 formed between the first and second substrates 140 and 146. The discharge spaces 117 may further include first and second thru-holes 131 and 139 to uniformly supply the discharge gas into to the discharge spaces 117 until the discharge gas has a uniformed pressure distribution in the discharge spaces 117.

Further, the light source body 110 may further include a reflection layer 143 disposed on the inner surface of the first substrate 140, a first fluorescent layer 144 disposed on the reflection layer 143, and a second fluorescent layer 148 disposed on an inner surface of the second substrate 146. The reflection layer 143 reflects the light incident to the first substrate 140 to the second substrate 146, and the first and second fluorescent layers 144 and 148 changes an invisible ray such as a ultra violate into a visible ray.

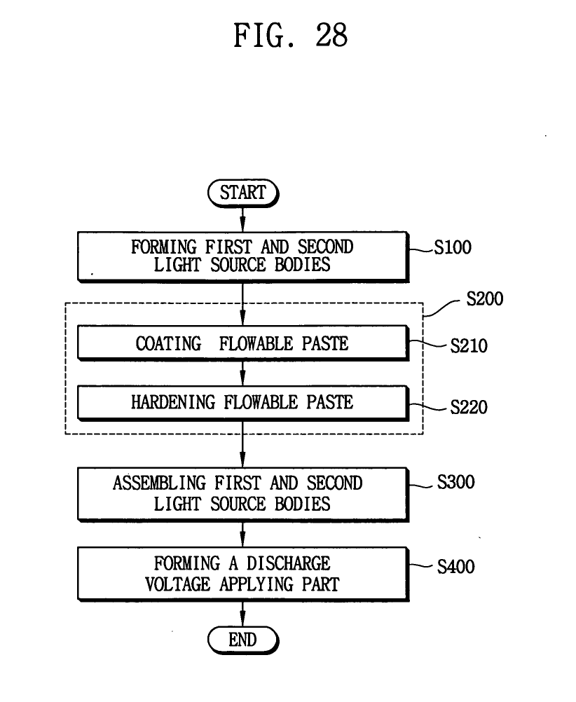

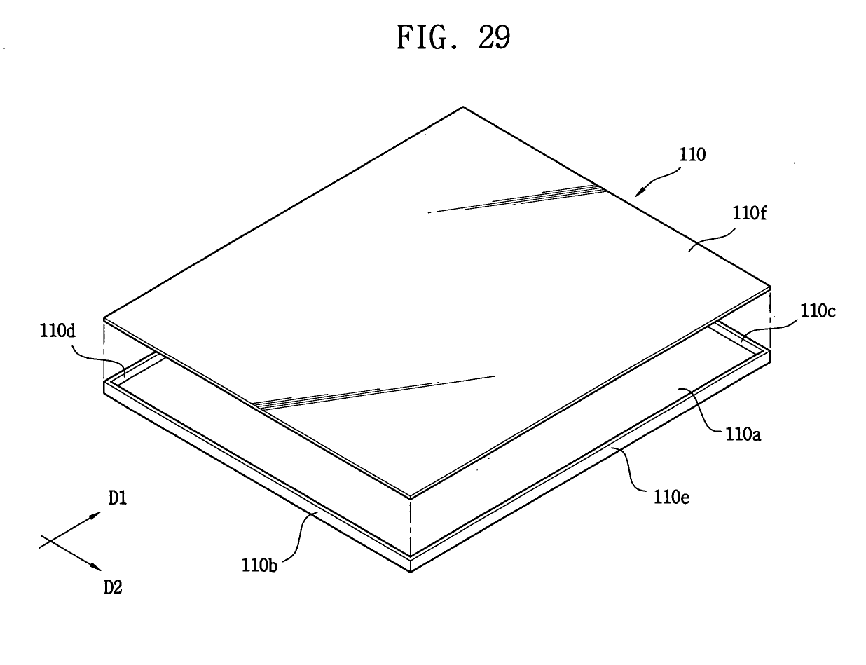

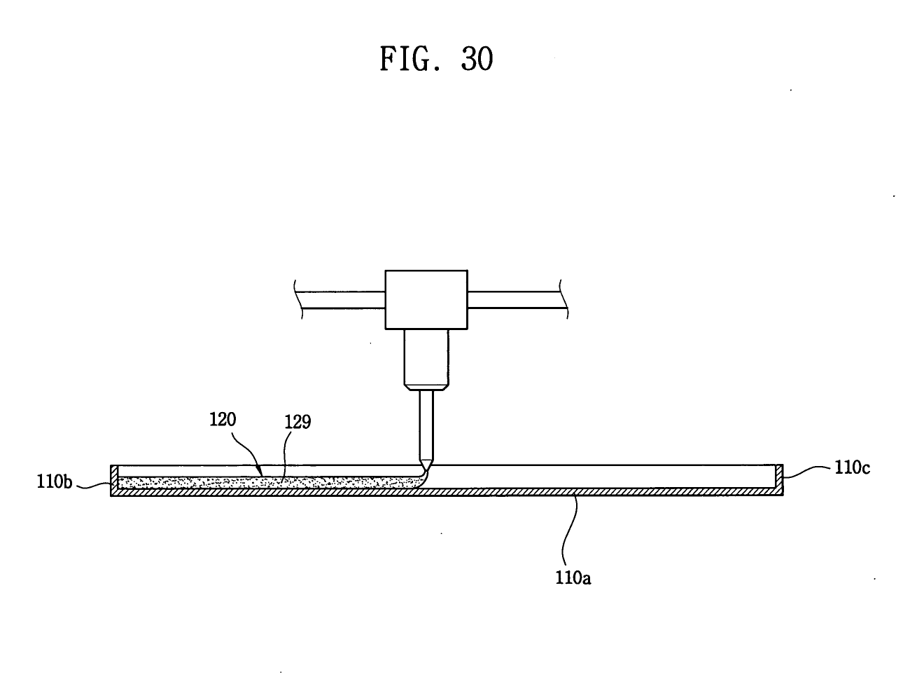

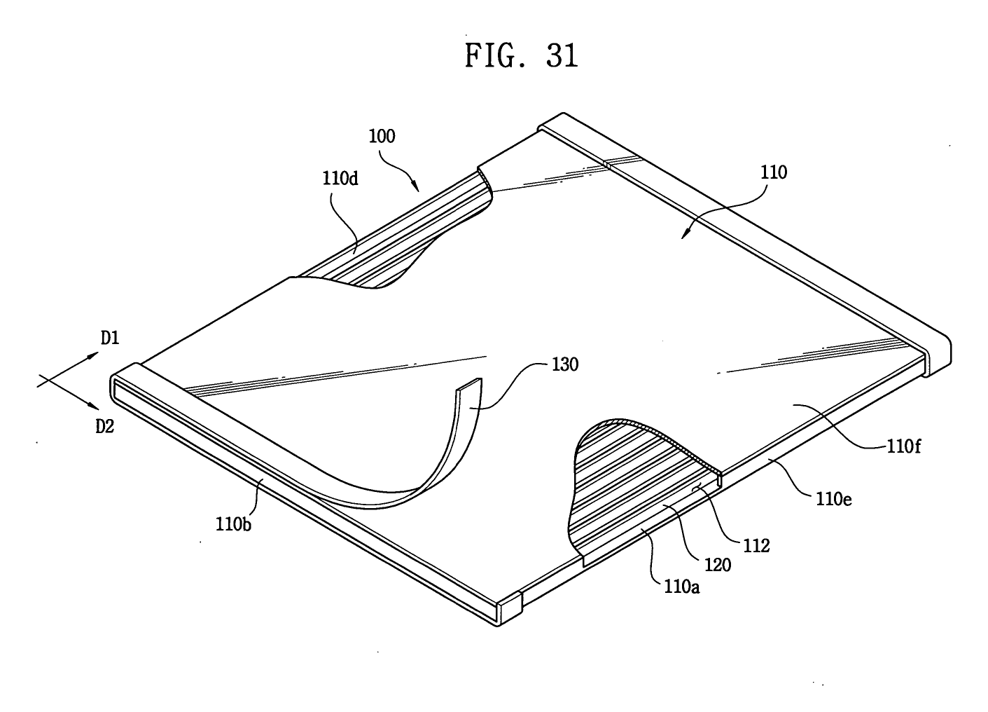

FIG. 28 is a flow chart illustrating a method of manufacturing a surface light source device according to another exemplary embodiment of the present invention. FIG. 29 is a perspective view showing a first light source body and a second light source body illustrated in the flow chart. FIG. 30 is a schematic view showing a flowable paste coated on the second light source body illustrated in the flow chart. FIG. 31 is a perspective view showing a discharge voltage applying part with the first and second light source bodies illustrated in the flow chart.

Referring to FIGS. 28 and 29, a light source body is first formed to include first and second light source bodies (S100). The first light source body is formed to have a light exit surface 110f and to be flat. A first fluorescent layer is formed on the light exit surface 110f. The second light source body is formed to include a receiving space having a bottom surface 110a and first to fourth sidewalls 110b, 110c, 110d and 110e integrally formed with the bottom surface 110a. For example, the bottom surface 110a of a flat and substantially rectangular shape is formed, and the four sidewalls 110b-110e are formed from the four edges of the bottom surface 110a such that the first and second sidewalls 110b and 110c face each other and the third and fourth sidewalls 110d and 110e face each other. Alternatively, the bottom surface 110a of the second light source body may be assembled to the first to fourth sidewalls 110b-110e after the bottom surface 110a and the first to fourth sidewalls 110b-110e are separately formed.

At least one space-dividing wall 120 is formed on the bottom surface 110a of the second light source body (S200). Particularly, a flowable paste 129, for example, mortar or a transparent material, is coated on the bottom surface 110a of the second light source body from the first or second sidewall 110b or 110c to the second or first sidewall 110c or 110b such that the longitudinal direction of the space-dividing wall 120 is substantially perpendicular to the first and second sidewalls 110b and 110c (S210). The flowable paste 129 is coated on the bottom surface 110a to have a predetermined space with adjacent coated paste. The flowable paste 129 is partially removed to form a thru-hole or a zigzag-shaped passage, and is hardened through a firing process (S220). A light reflection layer is formed on the second light source body on which the space-dividing wall 120 is formed. Further, a second fluorescent layer may be further formed on the light reflection layer.

A sealing member is disposed on the sidewalls 110b-110e and space-dividing wall 120 of the second light source body and the first light source body corresponding to the sidewalls 110b-110e and the space-dividing wall to assemble the first and second light source bodies, thereby forming the light source body 110 (S300). The first and second light source bodies are assembled such that the first and second fluorescent layers face each other.

After the assembling, a pair of discharge voltage applying parts 130 is formed on an outer surface of the light source body 110 (S400). The discharge voltage applying parts 130 are formed in a direction substantially perpendicular to a longitudinal direction of the space-dividing wall 120. For example, each of the discharge voltage applying parts 130 includes a metal tape so as to apply a discharge voltage to the discharge space.

The discharge voltage applying parts 130 may be formed to partially surround the third sidewall 110d, light exit surface 110f, fourth sidewall 110e and bottom surface 110a, or may be formed to partially surround the first sidewall 110b, bottom surface 110a and second sidewall 110c. By disposing the space-dividing wall 120 in the light source body 110 and disposing the discharge voltage applying part 130 on the surface of the light source body 110, the light source body 110 lowers the driving voltage and power consumption, and prevents the deformation or twist of the bottom surface 110a.

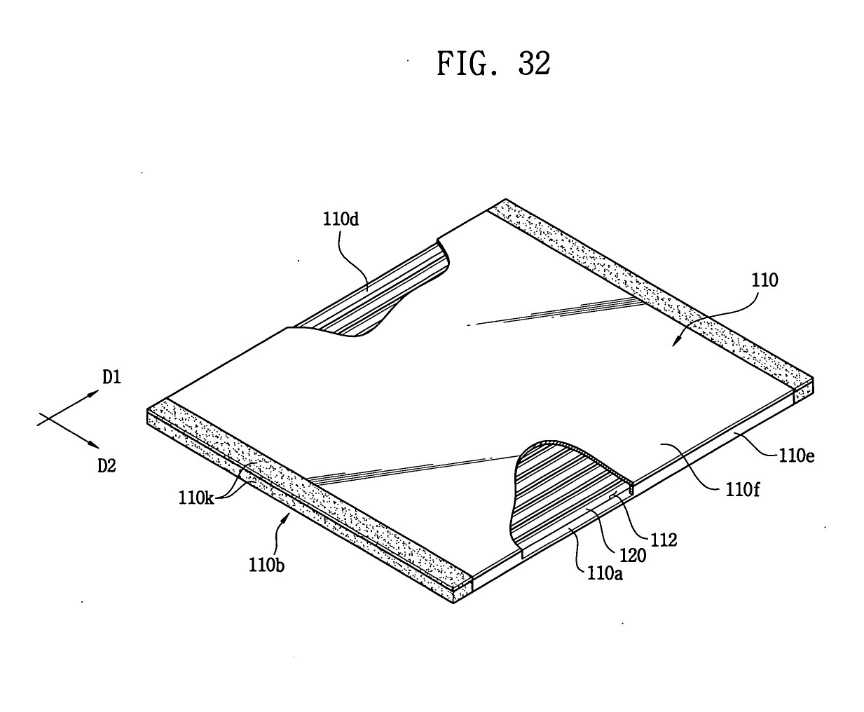

FIG. 32 is a perspective view showing a light source body according to another exemplary embodiment of the present invention. In FIG. 32, the same reference numerals denote the same elements in FIGS. 28 to 31, and thus the detailed descriptions of the same elements will be omitted.

After assembling a light source body 110, an attaching portion 110k is formed on positions where discharge voltage applying parts 130 are formed. The attaching portion 110k is formed in a direction substantially perpendicular to a longitudinal direction of a space-dividing wall 110. A surface roughness of the light source body 110 increases and a surface area of the light source body 110 also increases due to the forming of the attaching portion 110k.

The attaching portion 110k may be formed by a spray method that sprays sand particles on the outer surface of the light source body 110, or a dipping method that dips the light source body 110 into a chemical for corroding the light source body 110, for example, hydrogen fluoride, hydrofluoric acid or the like. Since the light source body 110 of FIG. 32 includes the attaching portion 110k formed between the outer surface of the light source body 110 and the discharge voltage applying parts 130, the discharge voltage applying parts 130 are prevented from deviating from the light source body 110.

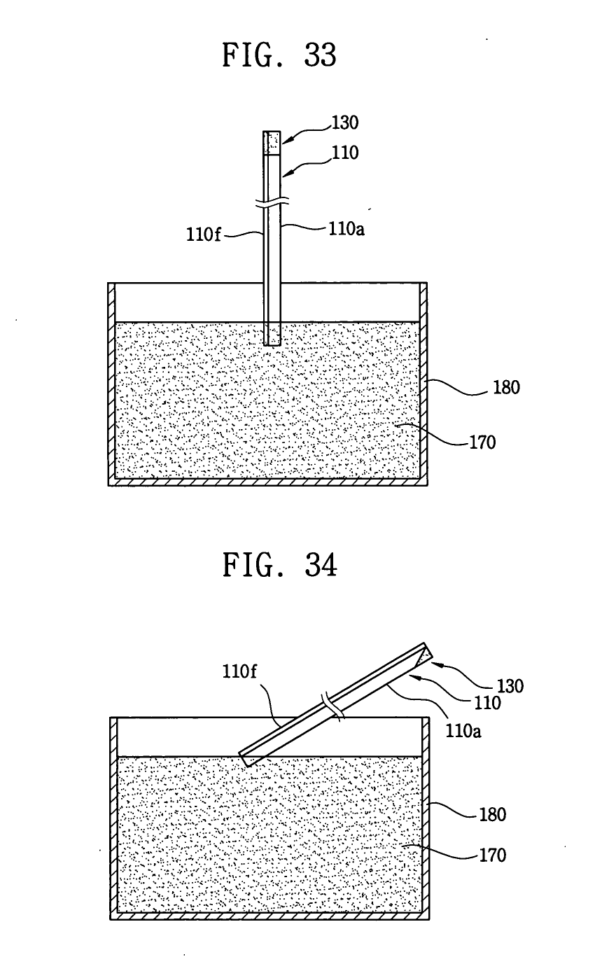

FIGS. 33 to 35 are schematic views illustrating a method of forming a discharge voltage applying part according to another exemplary embodiment of the present invention. In FIGS. 33 to 35, the same reference numerals denote the same elements in FIG. 32, and thus the detailed descriptions of the same elements will be omitted.

Referring to FIG. 33, a light source body 110 is dipped into a melted metal 170, for example, copper, zinc, silver, tin, indium tin oxide, indium zinc oxide and so on, in a furnace 180. The melted metal 170 has a melting point lower than that of the light source body 110. The melted metal 170 is adhered on an attaching portion 110k of the light source body 110, thereby forming the discharge voltage applying parts 130 on the outer surface of the light source body 110. The discharge voltage applying parts 130 may have various shapes depending on an inclination between a surface of the melted metal 170 in the furnace 180 and the light source body 110. Also, an amount of the light exited through a light exit surface 110f may be varied according to a shape of the discharge voltage applying parts 130. For example, as shown in FIG. 33, the light source body 110 is dipped into the melted metal 170 in a direction substantially perpendicular to the surface of the melted metal 170. Thus, a portion of the light exit surface 110f, a portion of the bottom surface 110a and sidewalls 110b, 110c, 110d and hoe are dipped into the melted metal 170, the discharge voltage applying parts 130 are formed on the light source body 110.

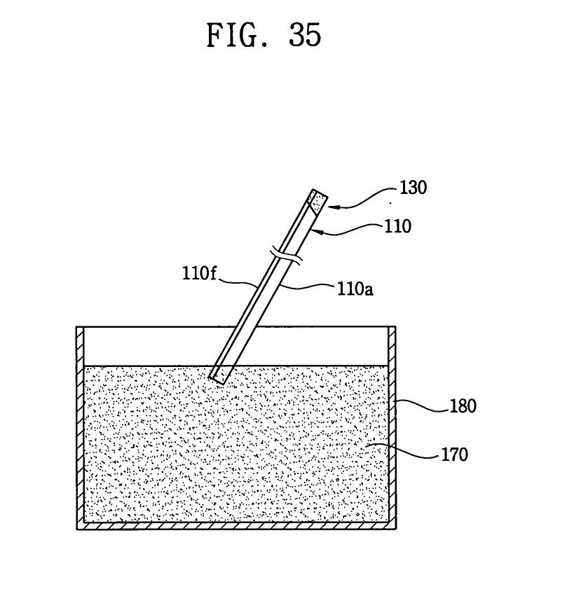

Alternatively, as shown in FIG. 34, the light source body 110 is dipped into the melted metal 170 in an inclined direction, with respect to the surface of the melted metal 170, such that the light exit surface 110f is not dipped into the melted metal 170. Thus, an area of the light exit surface 110f is increased, and an amount of the light exited through the light exit surface 110f is increased. Further, as shown in FIG. 35, the light source body 110 is dipped into the melted metal 170 in an inclined direction, with respect to the surface of the melted metal 170, such that the light exit surface 110f of the light source body 110 is also partially dipped into the melted metal 170. Thus, the areas of the discharge voltage applying parts 130 formed on the light source body 110 are increased. That is, the light source body 110 prevents reduction of the light exited through the light exit surface 110f. Since the discharge voltage applying parts 130 are formed using the melted metal 170, a process time for forming the discharge voltage applying part 130 on the light source body 110 is reduced.

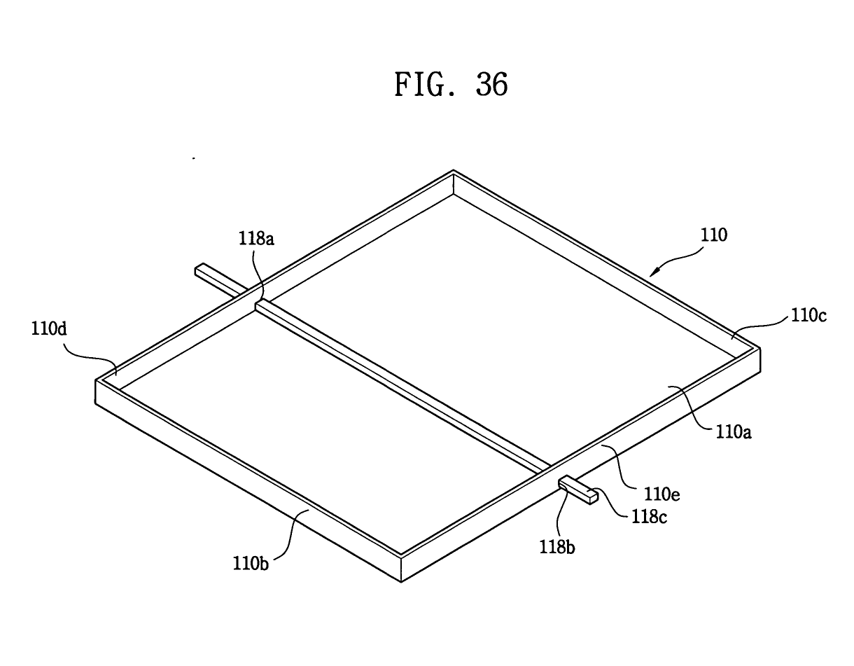

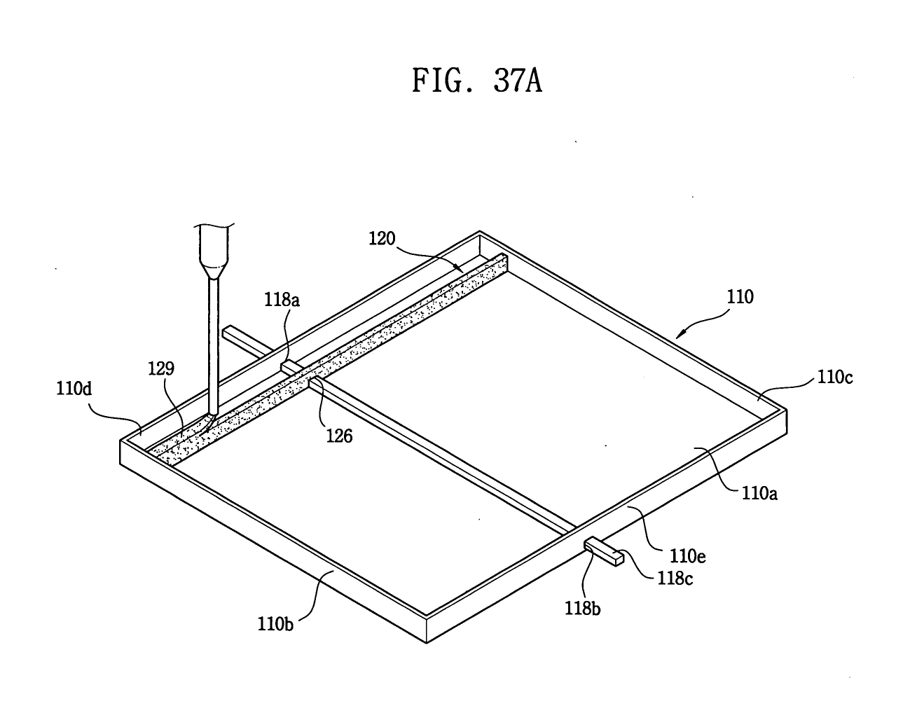

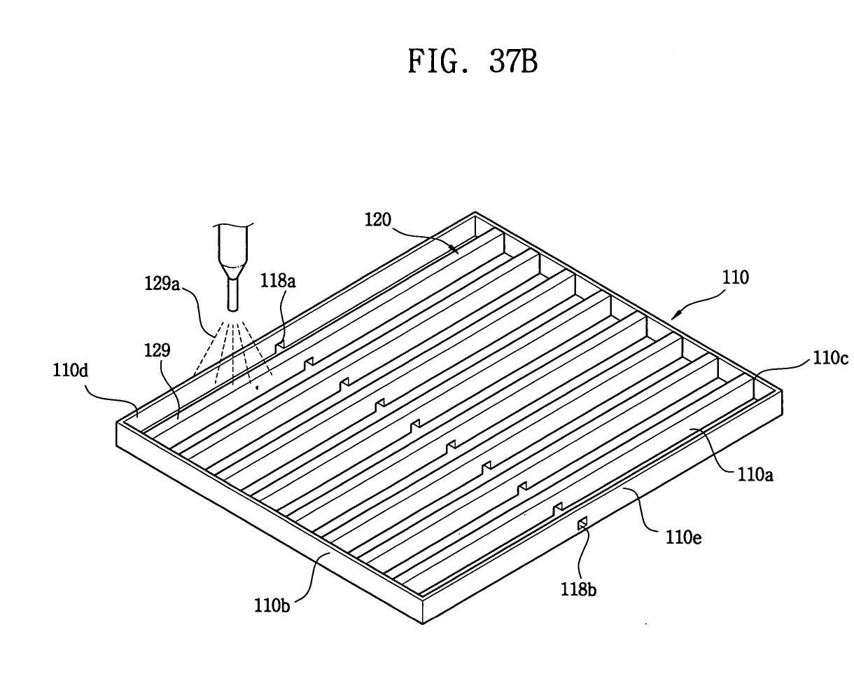

FIG. 36 is a perspective view showing a sealing bar coupled to a light source body according to another exemplary embodiment of the present invention. FIGS. 37A to 37C are schematic views illustrating a method of forming a surface light source device according to another exemplary embodiment of the present invention. In FIGS. 36 and 37, the same reference numerals denote the same elements in FIGS. 28 to 31, and thus the detailed descriptions of the same elements will be omitted.

Referring to FIGS. 36 to 37C, a light source body 110 includes third and fourth sidewalls 110d and 110e through which first and second sidewall thru-holes 118a and 118b are formed, respectively. The first and second sidewall thru-holes 118a and 118b face each other. A sealing bar 118c is inserted into the first and second sidewall thru-holes 118a and 118b through a receiving space between the third and fourth sidewalls 110d and 10e. FIG. 36 shows the sealing bar 118c making contact with a bottom surface 110a.

Referring to FIG. 37A, after inserting the sealing bar 118c into the first and second sidewall thru-holes 118a and 118b, a flowable paste 129 having a band shape is coated on the sealing bar 118c and the bottom surface 110a from the first sidewall 110b toward the second sidewall 110c, to have a predetermined space with adjacent coated pastes. As a result, a plurality of space-dividing wall 120 is formed on the bottom surface 110a, and is hardened through a firing process. When the sealing bar 118c is removed from the light source body 110 after the space-dividing wall 120 is hardened, a hole 126 is formed through the space-dividing wall 120.

Referring to FIG. 37B, a light reflection material 129a is sprayed on the bottom surface 110a and the space-dividing wall 120 so as to form a light reflection layer on the bottom surface 110a and the space-dividing wall 120. The light reflection material 129a comprises Al₂O₃ or TiO₃.

Referring to FIG. 37c, a fluorescent material 129b having a red fluorescent material, a green fluorescent material and a blue fluorescent material is sprayed on the light reflection layer to form a fluorescent layer on the light reflection layer. A discharge gas is injected into the light source body 110 through a discharge gas port 118c (See FIG. 7). The discharge gas may uniformly be provided to each of the discharge spaces through the thru-hole 126 formed at the space-dividing wall 120.

The sealing bar 118c is re-inserted into the first and second sidewall thru-holes 118a and 118b at the third and fourth sidewalls 110d and 110e and the thru-hole 126 at the space-dividing wall 120, and the sealing bar 118c is hardened, through a firing process or with an adhesive, to be coupled to the space-dividing wall 120 and the thru-hole 126. A pair of discharge gas applying parts 130 is formed on the outer surface of the light source body 110. Since the thru-hole 126 is simultaneously formed with the space-dividing wall 120 that divides the space of the light source body 110 into a plurality of discharge spaces, and the thru-hole 126 is sealed after the discharge gas is supplied to each discharge spaces through the thru-hole 126, the pressure of the discharge gas is uniformly maintained at each discharge spaces.

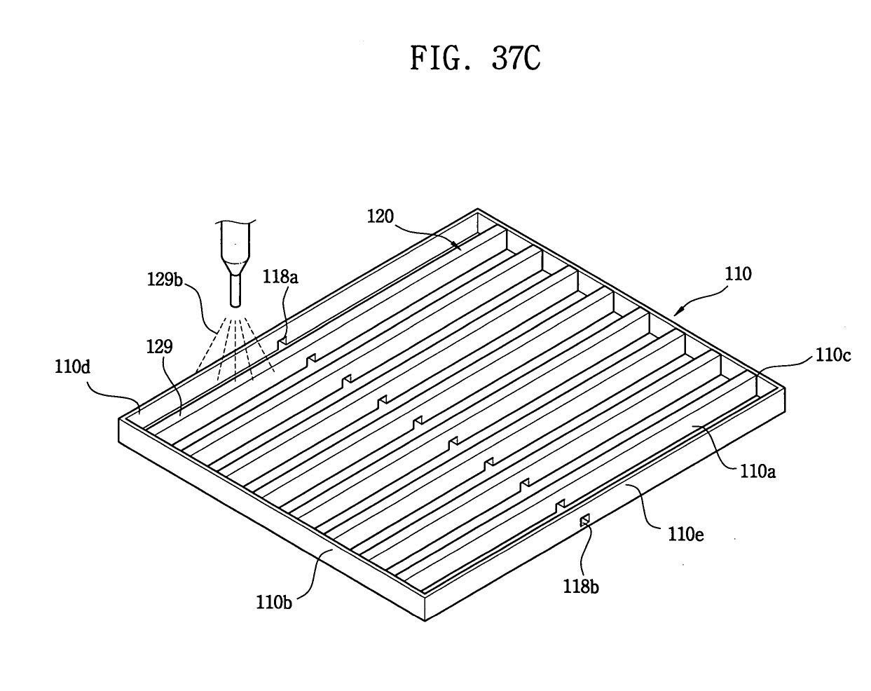

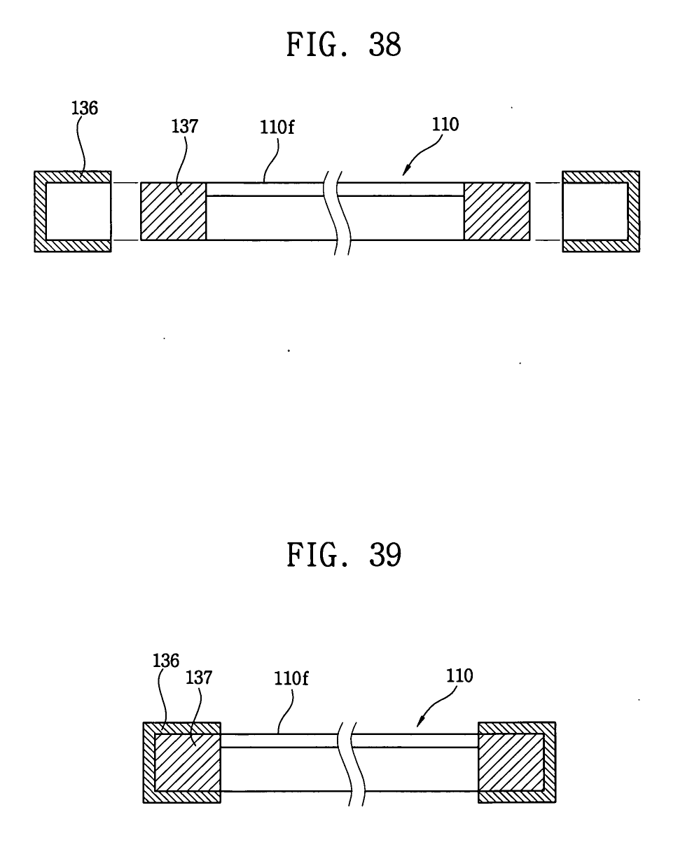

FIGS. 38 and 39 are schematic views illustrating a method of forming a surface light source device according to another exemplary embodiment of the present invention. In FIGS. 38 and 39, the same reference numerals denote the same elements in FIGS. 33 to 35, and thus the detailed descriptions of the same elements will be omitted.

Referring to FIGS. 38 and 39, a light source body 110 is dipped into a first melted metal having a first melting point and a first hardness, so that a pair of second discharge voltage applying parts 137 is formed at both ends of the light source body 110. A second metal having a second melting point and a second hardness higher than the first melting point and first hardness is coupled to both ends of the light source body 110 to form a pair of first discharge voltage applying parts 136. The first discharge voltage applying parts 136 include a cap shape to surround the second discharge voltage applying parts 137. The first and second discharge voltage applying parts 136 and 137 are melted at a high temperature and cooled. During the melting and cooling, the second discharge gas applying parts 137 are melted and fixed between the first discharge gas applying parts 136 and the light source body 110.

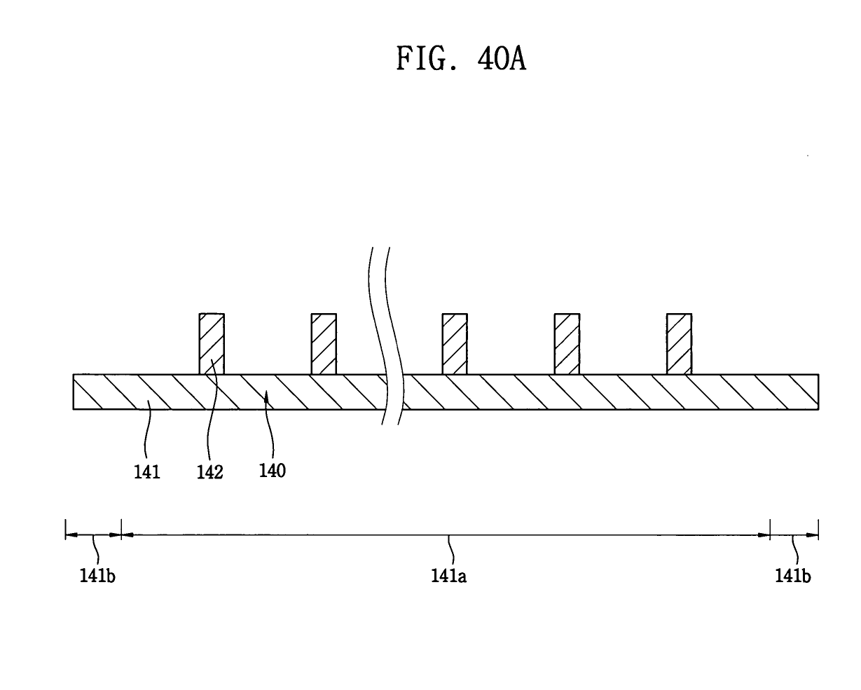

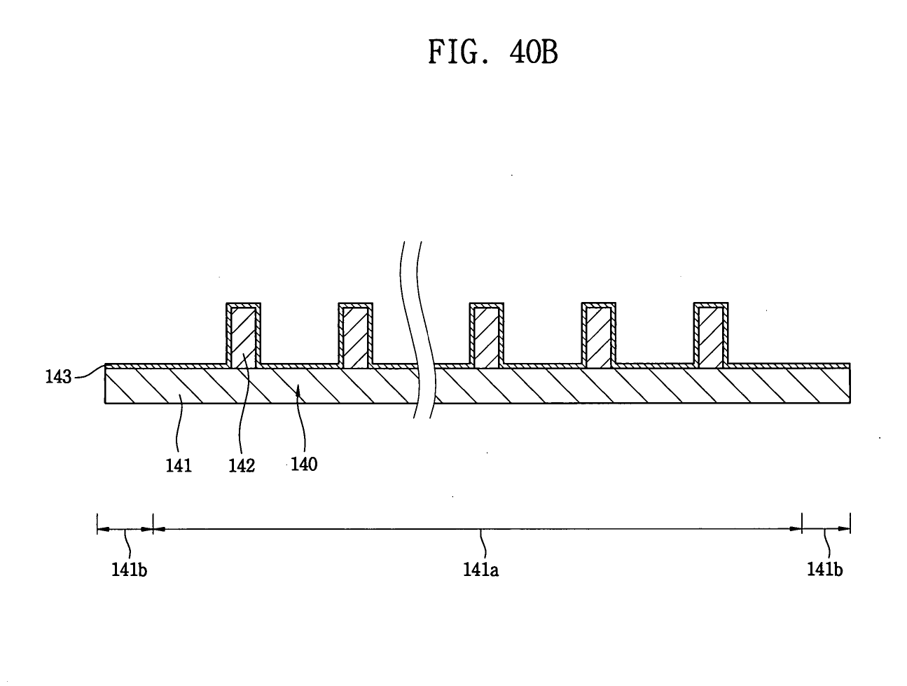

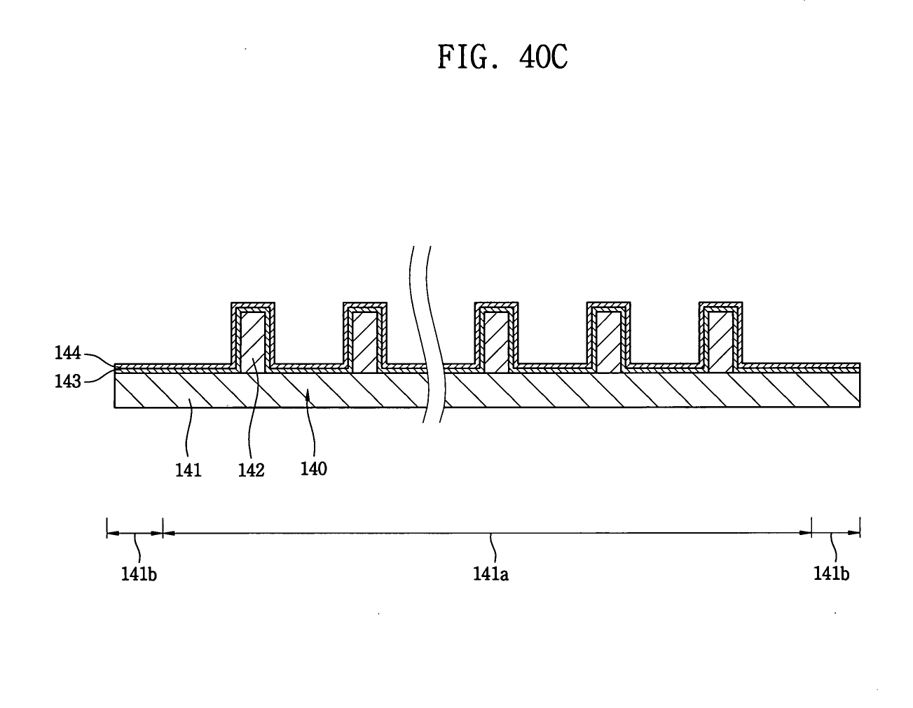

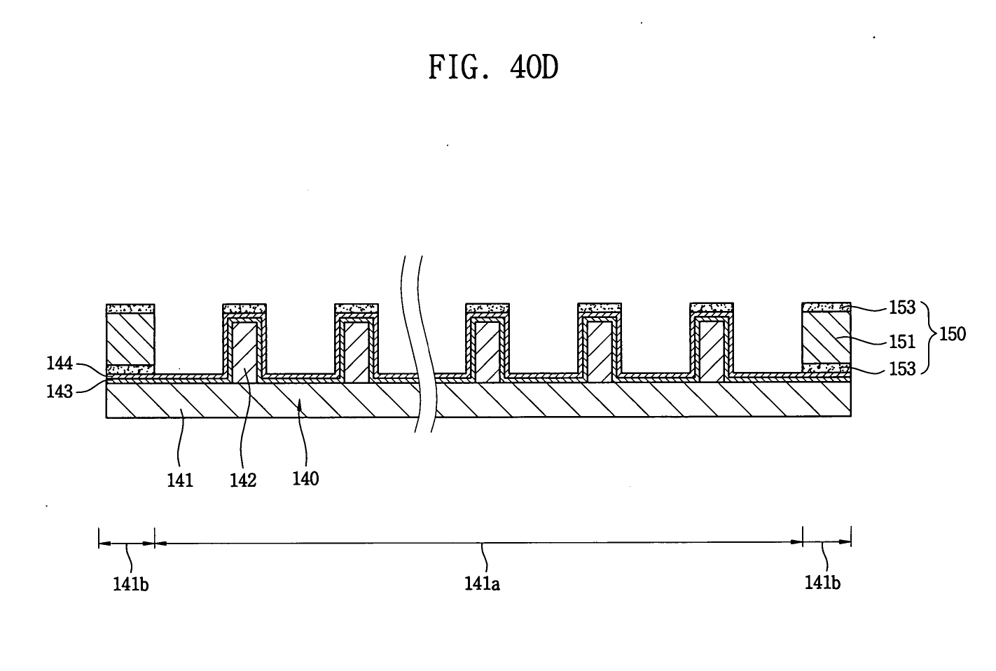

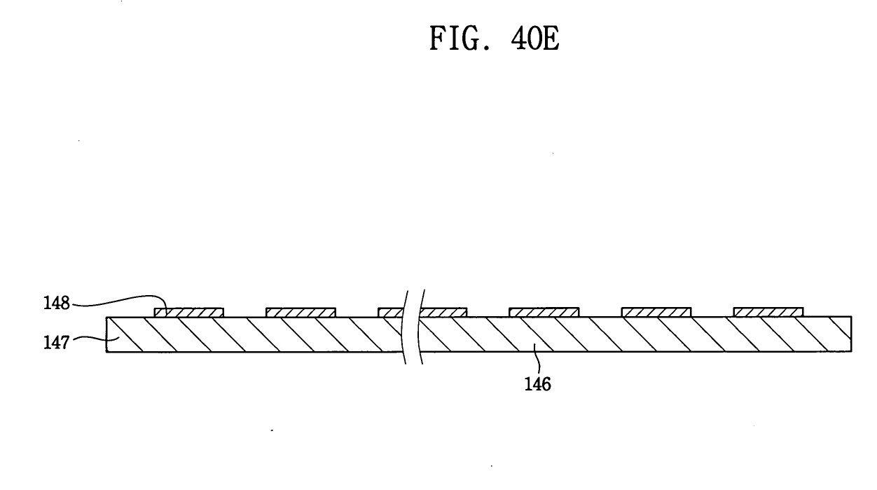

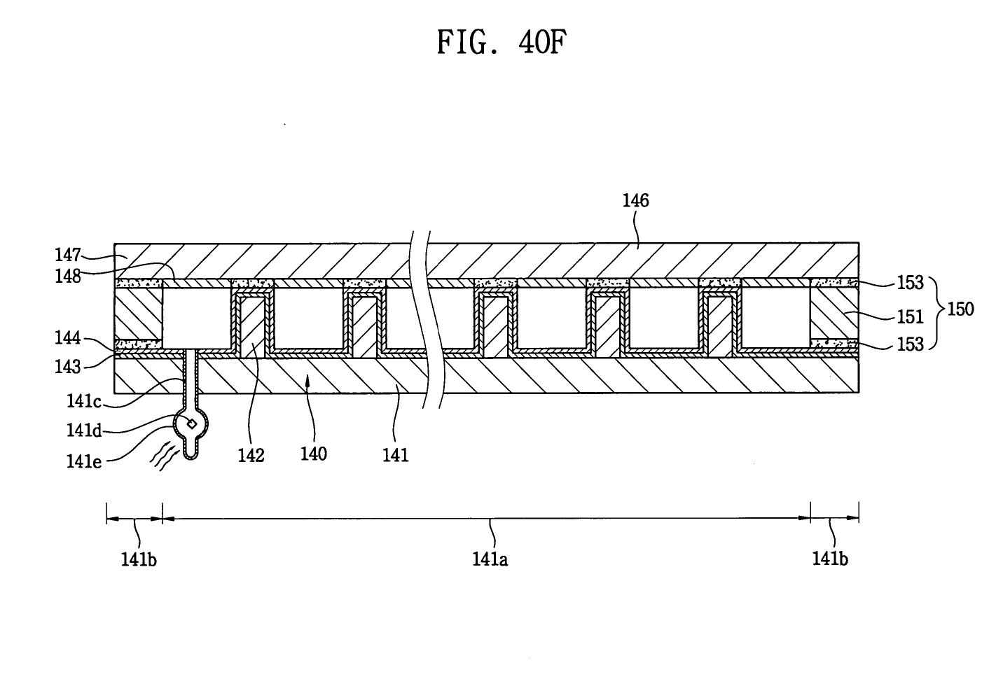

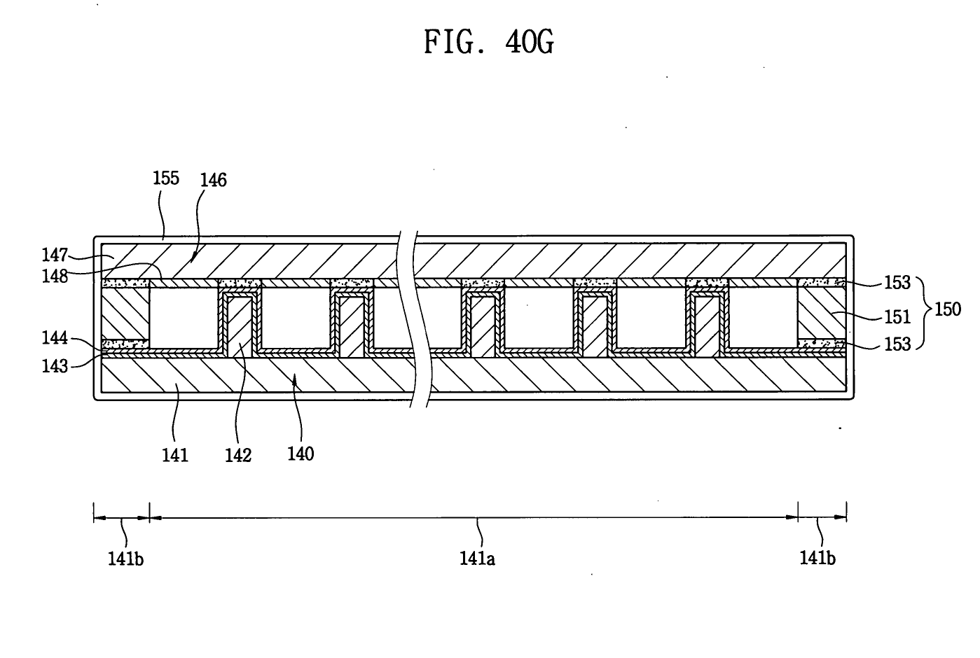

FIGS. 40A to 40G are schematic views illustrating a method of manufacturing a surface light source device according to another exemplary embodiment of the present invention. FIG. 40A is a schematic view showing a first transparent substrate and a plurality of space-dividing walls disposed on the first transparent substrate.

Referring to FIG. 40A, a first transparent substrate 141 is formed to include a light exiting area 141a and a sealing area 141b. The first transparent substrate 141 has a flat and substantially rectangular shape, and the sealing area 141b has a frame shape formed along the edges of the light exiting area 141a. On the light exiting area 141a of the first transparent substrate 141, a plurality of space-dividing walls 142 is formed in parallel to provide a plurality of discharge spaces on the light exiting area 141a. The space-dividing walls 142 each include, for example, a mortar material or a transparent material, and have an identical length to each other. The space-dividing walls 142 may be alternately arranged on the light exiting area 141a such that their ends are arranged in a zigzag shape on the light exiting area 141a. Instead of forming the zigzag shape, the space-dividing walls 142 may have thru-holes for uniformly distributing discharge gas in the discharge spaces.

FIG. 40B is a schematic view showing a light reflection layer on a first transparent substrate. Referring to FIG. 40B, a light reflection material is coated on the first transparent substrate 141 and the space-dividing walls 142 through a spraying process. For example, the light reflection material includes Al₂O₃ or TiO₃. The light reflection layer 143 reflects the light to be supplied to the first transparent substrate 141 to a second transparent substrate 147.

FIG. 40C is a schematic view showing a first fluorescent layer on the light reflection layer shown in FIG. 40B. Referring to FIG. 40C, a fluorescent material is coated on the light reflection layer 143 through a spraying process to form a first fluorescent layer 144. For example, the first fluorescent layer 144 comprises a red fluorescent material, a green fluorescent material and a blue fluorescent material having an equal content to each other. The formed first transparent substrate 141, space dividing walls 142, light reflection layer 143 and first fluorescent layer 144 constitutes a first substrate 140.

FIG. 40D is a schematic view showing a sealing member on the first substrate shown in FIG. 40C. Referring to FIG. 40D, a sealing member 150 is disposed on the area of the first fluorescent layer 144 corresponding to the sealing area 141b of the first transparent substrate 141. The sealing member 150 is formed to have a rectangular-shaped frame and a substantially identical surface area to that of the sealing area 141b. The sealing member 150 includes a body 151 having a material equal to or different from that of the first transparent substrate 141. A sealant 153 is formed on both ends of the body 151, one end facing the first transparent substrate 141 and the other end facing a second transparent substrate 147 (See FIG. 40F). The sealant 153 is also formed on the area of the first fluorescent layer 144 formed on the space-dividing walls 142.

FIG. 40E is schematic view showing a second substrate including a second transparent substrate and a second fluorescent layer. Referring to FIG. 40E, the second transparent substrate 147 is formed to have substantially identical shape to that of the first transparent substrate 141. The second fluorescent layer 148 is formed on the second transparent substrate 147. Alternatively, the second fluorescent layer 148 may be formed on the second transparent substrate 147 except the area corresponding to the space-dividing walls 142 of the first substrate 140, through a print process. For example, the second fluorescent layer 148 comprises a red fluorescent material, a green fluorescent material and a blue fluorescent material having an equal content to each other. The second fluorescent layer 148 is coated on a roller, and printed on the second transparent substrate 147 by means of the roller, except the areas corresponding to the space-dividing walls 142.

FIG. 40F is a schematic view showing a light source body in which the first and second substrates are assembled. Referring to FIG. 40F, a discharge gas port 141c is formed through the first transparent substrate 141, the light reflection layer 143 and the first fluorescent layer 144. A discharge gas supply pipe 141d is combined with the discharge gas port 141c. The discharge gas supply pipe 141d includes, for example, a opened end and a tube-shaped closed end. The opened end is combined with the discharge gas port 141c. Alternatively, the discharge gas supply pipe 141d may be simultaneously formed with the first transparent substrate 141. The discharge gas supply pipe 141d has a discharge gas impregnated portion 141e impregnated with a discharge gas, for example, mercury, argon, xenon, krypton and so on. For example, when the discharge gas impregnated portion 141e is heated by a high frequency, the discharge gas is discharged from the discharge gas impregnated portion 141e. The discharge gas from the discharge gas impregnated portion 141e is uniformly provided to each of the discharge spaces through the discharge gas port 141c. Also, the discharge gas impregnated portion 141e may operate as a gas getter that collects impurities, for example, oxygen, hydrogen or the like, in the discharge spaces.

FIG. 40G is a schematic view showing a surface light source device in which a pair of discharge voltage applying parts is coupled to the light source body. Referring to FIG. 40G, after the discharge gas is injected into the discharge spaces, the discharge gas supply pipe 141d is separated from the discharge gas port 141c and the discharge gas port 141c is partially melted to be sealed.

The pair of discharge voltage applying parts 155 is formed on the light source body having the first substrate 140, the second substrate 146 and the sealing member 150. Particularly, the discharge voltage applying parts 155 are outwardly disposed on the first and second substrates 140 and 146 so as to cause discharging in the discharge spaces, thereby generating a visible ray. The discharge voltage applying parts 155 are arranged in a direction substantially perpendicular to a longitudinal direction of the space-dividing walls 142. For example, the discharge voltage applying parts 155 have a band shape to outwardly surround the light source body. The discharge voltage applying parts 155 are attached on the outer surfaces of the light source body with a conductive adhesive. The discharge voltage applying parts 155 include, for example, lead, copper, zinc, silver, tin, indium tin oxide or indium zinc oxide.

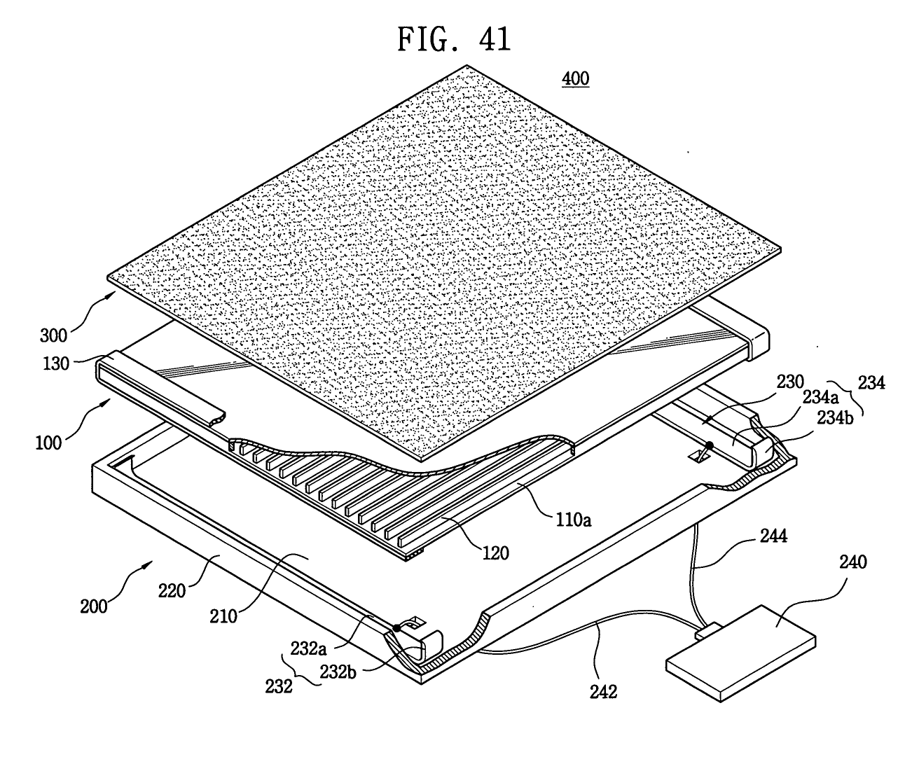

FIG. 41 is an exploded perspective view showing a backlight assembly according to another exemplary embodiment of the present invention. In FIG. 41, the same reference numerals denote the same elements in FIGS. 1 to 2, and thus the detailed descriptions of the same elements will be omitted.

Referring to FIG. 41, a backlight assembly 400 includes a surface light source device 100, a receiving container 200 and an optical member 300. The receiving container 200 includes a bottom surface 210, a sidewall 220, a discharge voltage applying module 230 and an inverter 240. The bottom surface 210 of the receiving container 200 has a size suitable for receiving the surface light source device 100 and a shape identical to that of the surface light source device 100. For example, the bottom surface 210 has a flat and substantially rectangular shape identical to that of the bottom surface 110a of the surface light source device 100. The sidewall 220 is vertically extended from the bottom surface 210 of the receiving container 200 so as to prevent deviation of the surface light source device 100 from the receiving container 200.

The discharge voltage applying module 230 applies a discharge voltage to a pair of discharge voltage applying parts 130 of the surface light source device 100. The discharge voltage applying module 230 includes a first discharge voltage applying module 232 and a second discharge voltage applying module 234, each module 232 or 234 is formed on an area of the bottom surface 210 on which each of the discharge voltage applying parts 130 is disposed For example, the first discharge voltage applying module 232 includes a first conductive body 232a having a shape substantially identical to each of the discharge voltage applying parts 130, and a first conductive clip 232b integrally formed at both ends of the first conductive body 232a. The second discharge voltage applying module 234 includes a second conductive body 234a having a shape substantially identical to each of the discharge voltage applying parts 130 and being opposite to the first conductive body 232a, and a second conductive clip 234b integrally formed at both ends of the second conductive body 234a. The discharge voltage applying parts 130 formed on the surface light source device 100 are disposed on the first and second conductive bodies 232a and 234b and fixed to the first and second discharge voltage applying modules 232 and 234 with the first and second conductive clips 232b and 234b, respectively.

The inverter 240 applies the discharge voltage to the first and second discharge voltage applying modules 232 and 234. The inverter 240 is electrically connected to the first discharge voltage applying module 232 via a first power supply line 242, and is electrically connected to the second discharge voltage applying module 234 via a second power supply line 244.

The backlight assembly 400 further includes the optical member 300 disposed on the surface light source device 100. The optical member 300 diffuses the light emitted from the surface light source device 100 and further improves the uniformity of the brightness distribution of the light emitted from the surface light source device 100. However, the backlight assembly 400 may be formed without the optical member 300, because the surface light source device 100 supplies the uniformity of the brightness distribution of light by uniformly distributing the discharge gas into the discharge spaces.

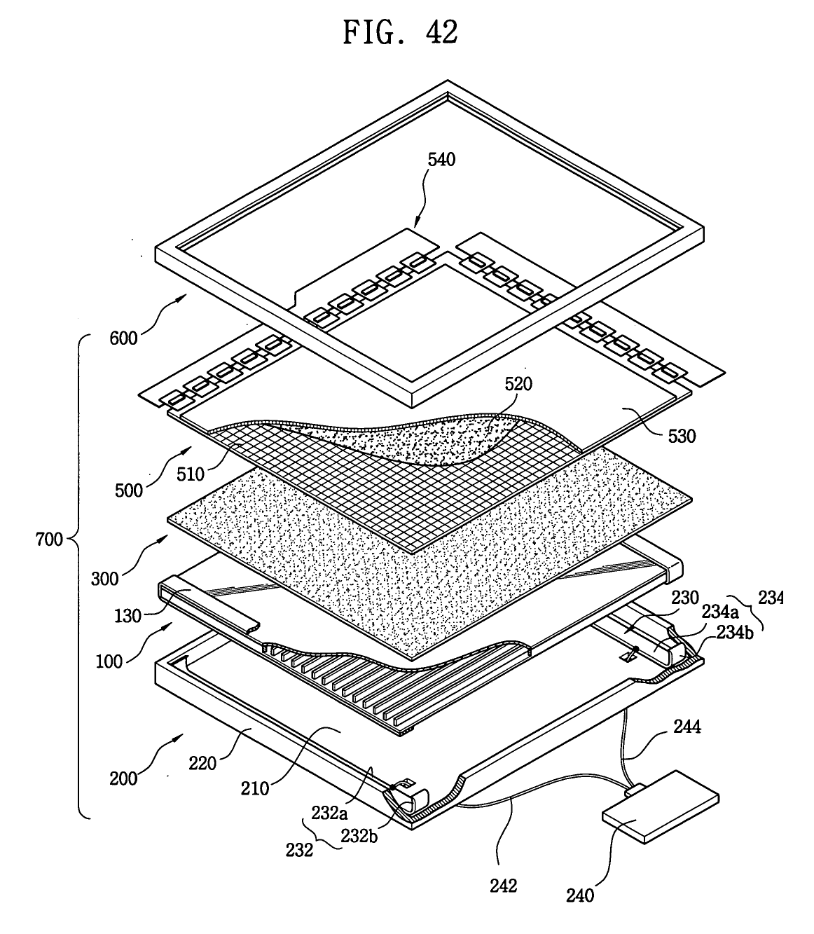

FIG. 42 is an exploded perspective view showing an LCD apparatus according to a further exemplary embodiment of the present invention. In FIG. 42, the same reference numerals denote the same elements in FIG. 41, and thus the detailed descriptions of the same elements will be omitted.

Referring to FIG. 42, an LCD apparatus 700 includes a backlight assembly 400, an LCD panel 500 and a chassis 600. The LCD panel 500 receives the light emitted from the surface light source device 100 and displays an image using the receiving light. The LCD panel 500 includes a TFT substrate 510, liquid crystal 520, a color filter substrate 530 and a driving module 540. The TFT substrate 510 includes a pixel electrode arranged in a matrix configuration, a thin film transistor for applying a driving voltage to the pixel electrode, a gate line and a data line. The color filter substrate 530 includes a color filter facing the pixel electrode formed on the TFT substrate 510 and a common electrode formed on the color filter. The liquid crystal is interposed between the TFT substrate 510 and the color filter substrate 530.

The LCD panel 500 is received into the receiving container 200 of the backlight assembly 400, and the edges of the LCD panel 500 are covered by the chassis 600. The chassis 600 is coupled to the receiving container 200 of the backlight assembly 400 in a hook-type manner. The chassis 600 prevents brittleness of the LCD panel 500 and deviation of the LCD panel 500 from the backlight assembly 400.

According to exemplary embodiments of the invention, a surface light source device includes at least one space-dividing wall for uniformly distributing discharge gas into discharge spaces and a pair of discharge voltage applying parts capable of causing discharging in the discharge spaces with a lower driving voltage. Thus, the surface light source device emits the light having the uniformity brightness and lowers the power consumption. Therefore, an LCD apparatus including the surface light source device improves a display quality and lowers power consumption. Further, since the LCD apparatus may be manufactured without employing a separate optical member, the LCD apparatus may have a reduced weight and size, and its manufacturing cost may be decreased.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A surface light source device, comprising:
a light source body including:
a bottom plate;
a top plate which is disposed over the bottom plate to form a flat receiving space between the bottom plate and the top plate, the flat receiving space receiving discharge gas; and
at least one space-dividing wall which is disposed on the bottom plate and divides the flat receiving space into at least two discharge spaces; and
at least one discharge voltage applying part which is disposed on an outer surface of the light source body and applies a discharge voltage to the light source body.

2. The surface light source device according to claim 1, wherein the surface light source device includes a pair of the discharge voltage applying parts disposed at two ends of the outer surface of the light source body, the two ends facing each other and being perpendicular to a longitudinal direction of the space-dividing wall, respectively.

3. The surface light source device according to claim 2, wherein the discharge voltage applying parts each include a band shaped metal closely adhered to the ends of the outer surface of the light source body or attached to the ends of the outer surface of the light source body with a conductive adhesive.

4. The surface light source device according to claim 3, wherein the metal of the discharge voltage applying parts includes lead, copper, zinc, silver, tin, indium tin oxide or indium zinc oxide.

5. The surface light source device according to claim 1, wherein the light source body further includes:
first to fourth sidewalls each perpendicular to the bottom plate, the first and second sidewalls facing each other, and the third and fourth sidewalls facing each other,
wherein the bottom plate, the first to fourth sidewalls and the top plate defines the flat receiving space.

6. The surface light source device according to claim 1, wherein the top plate includes a light exit surface disposed over the flat receiving space.

7. The surface light source device according to claim 1, further comprising:
at least two fluorescent layers to surround the discharge spaces, respectively.

8. The surface light source device according to claim 5, wherein the space-dividing wall is extended in a first direction in the flat receiving space and arranged in a second direction in the flat receiving space, and
wherein the space-dividing wall includes a first end coupled to the first sidewall, a second end coupled to the second sidewall, a lower surface coupled to the bottom plate and an upper surface coupled to the top plate.

9. The surface light source device according to claim 1, wherein the discharge gas includes a combination gas of mercury with at least one of an argon gas, a neon gas, a xenon gas and a krypton gas.

10. The surface light source device according to claim 1, wherein the light source body further includes at least one thru-hole at the space-dividing wall in which the discharge gas is supplied.

11. The surface light source device according to claim 10, wherein the thru-hole is disposed at a lower portion of the space-dividing wall with a predetermined space from a position of the discharge voltage applying part.

12. The surface light source device according to claim 5, wherein the light source body further includes at least one thru-hole at a portion of the space-dividing wall adjacent to the bottom plate.

13. The surface light source device according to claim 5, wherein the light source body further includes at least one thru-hole at either end of the space-dividing wall, the end of the space-dividing wall making contact with the first or second sidewall parallel to a longitudinal direction of the discharge voltage applying part.

14. The surface light source device according to claim 13, wherein the discharge voltage applying part includes a cut-away portion at a portion where the thru-hole is overlapped with the discharge voltage applying part.

15. The surface light source device according to claim 8, wherein the light source body further includes first and second sidewall thru-holes each formed at the third and fourth sidewalls such that the first and second sidewall thru-holes are arranged with the true-hole in a straight line.

16. The surface light source device according to claim 15, wherein the light source body further includes a sealing bar inserted in the true-hole and the first and second sidewall thru-holes.

17. The surface light source device according to claim 12, wherein the light source body further includes a discharge gas port formed through the bottom plate to decompress an inside of the light source body before supplying the discharge gas in the flat receiving space.

18. The surface light source device according to claim 5, wherein the discharge voltage applying part includes a first conductor member disposed over the first sidewall or the second sidewall, and a second conductive member extended from the first conductive member toward an outer surface of the bottom plate in a first predetermined width, and
wherein the first and second sidewalls are perpendicular to a longitudinal direction of the space-dividing wall.

19. The surface light source device according to claim 18, wherein the discharge voltage applying part further includes a third conductive member extended from both ends of the first conductive member, both ends of the second conductive member or both ends of the first and second conductive members, toward the third sidewall and the fourth sidewall.

20. The surface light source device according to claim 18, wherein the discharge voltage applying part further includes a fourth conductive member extended from the first conductive member toward the light exit surface, in a second predetermined width, the second predetermined width being narrower than the first predetermined width.

21. The surface light source device according to claim 20, wherein the discharge voltage applying part further includes a fifth conductive member extended from both ends of the first conductive member, both ends of the second conductive member or both ends of the first and second conductive members, toward the third and fourth sidewalls.

22. The surface light source device according to claim 5, wherein a portion of the bottom plate, which makes contact with the discharge voltage applying part, has a first thickness, and a remaining portion of the bottom plate has a second thickness greater than the first thickness.

23. The surface light source device according to claim 22, wherein the first thickness is substantially identical to a thickness of the top plate.

24. The surface light source device according to claim 1, wherein the light source body includes a plurality of the space-dividing walls arranged on the bottom plate in parallel each other, and
wherein the space-dividing walls each have a length less than a length of the bottom plate, and are arranged on the bottom plate with alternately coupling both ends of the bottom plate in a width direction of the bottom plate.

25. The surface light source device according to claim 2, wherein each of the discharge voltage applying parts includes a first discharge voltage applying part coupled to one end of the two ends of the outer surface of the light source body and a second discharge voltage applying part disposed between the light source body and the first discharge voltage applying part.

26. The surface light source device according to claim 25, wherein the first discharge voltage includes lead, copper, zinc, silver or tin.

27. The surface light source device according to claim 25, wherein the second discharge voltage applying part is melted between the light source body and the first discharge voltage applying part.

28. The surface light source device according to claim 25, wherein the light source body further includes an attaching portion on the outer surface where the second discharge voltage applying part is disposed; and
wherein the attaching portion has a surface roughness greater than the surface roughness of a remaining portion of the outer surface, and has a surface area greater than the surface area of the remaining portion of the outer surface.

29. The surface light source device according to claim 28, wherein the attaching portion includes a plurality of protrusion portions.

30. The surface light source device according to claim 5, further comprising a light reflection layer formed on inner surfaces of the bottom plate and the first to fourth sidewalls.

31. A surface light source device, comprising:
a light source body including:
a flat bottom surface;
first to fourth sidewalls each perpendicular to the bottom surface, the first and second sidewalls facing each other and the third and fourth sidewalls facing each other,
a light exit surface disposed on the first to fourth sidewalls and over the bottom surface, wherein the first to fourth sidewalls and the light exit surface define a flat receiving space to receive discharge gas;
at least one space-dividing portion integrally formed with the bottom surface or the light exit surface to divide the flat receiving space into at least two discharge spaces, the space dividing portion being extended in a direction perpendicular to the first and second sidewalls; and
at least two fluorescent layers each surrounding the discharge spaces; and
at least one discharge voltage applying part disposed at an outer surface of the light source body in a direction perpendicular to a longitudinal direction of the space-dividing portion, the discharge voltage applying parts applying discharge voltage to the light source body to generate a visible ray from the discharge gas via the fluorescent layers.

32. The surface light source device according to claim 31, wherein the space-dividing portion includes an end facing the light exit surface or the bottom surface, an adhesive being formed on the end.

33. The surface light source device according to claim 32, wherein the end of the space-dividing portion is rounded to reduce an area that makes contact with the bottom surface or the light exit surface.

34. A surface light source device, comprising:
a first substrate including:
a first transparent substrate which includes a first light exiting area and a first sealing area surrounding the first light exiting area, the first transparent substrate being flat and rectangular,
at least one space-dividing wall which is disposed at the first light exiting area and divides the first light exiting area into at least two discharge spaces;
a light reflecting layer which is disposed on the first transparent area and the space-dividing wall; and
a first fluorescent layer which is disposed on the light reflection layer, a second substrate including:
a second transparent substrate which includes a second light exiting area and a second sealing area surrounding the second light exiting area; and
a second fluorescent layer which is disposed on the second light exiting area of the second transparent substrate, the second fluorescent layer facing the first fluorescent layer of the first substrate;
a sealing member which is disposed between the first and second sealing areas of the first and second transparent substrates; and
at least one discharge voltage applying part which is disposed on outer surfaces of the first and second substrates in a direction perpendicular to a longitudinal direction of the space-dividing wall.

35. The surface light source device according to claim 34, wherein the sealing member includes a sealant formed on ends of the sealing member facing the first sealing areas and the second sealing area, respectively.

36. The surface light source device according to claim 34, wherein the second fluorescent layer includes a hole at an area facing the space-dividing wall of the first substrate.

37. The surface light source device according to claim 36, wherein the sealing member includes a sealant filled in the hole of the second fluorescent layer.

38. The surface light source device according to claim 34, wherein the space-dividing wall includes a thru-hole formed through the space-dividing wall, discharge gas being supplied into the discharge spaces through the thru-hole.

39. The surface light source device according to claim 34, wherein the first substrate includes a plurality of the space-dividing walls at the first light exiting area of the first transparent substrate, and the space-dividing walls are alternately arranged at the first light exiting area to form a zigzag passage in the discharge passages, discharge gas being supplied into the discharge spaces through the zigzag passage.

40. The surface light source device according to claim 34, wherein the first transparent substrate further includes a discharge gas port for supplying discharge gas at the first light exiting such that the discharge area port is not overlapped with the space-dividing wall.

41. The surface light source device according to claim 34, wherein the light reflection layer includes Al₂O₃ or TiO₃.

42. A surface light source device, comprising:
a first substrate;
a second substrate which is disposed on the first substrate, wherein the second substrate includes at least two protrusions having a predetermined height with respect to the first substrate, the protrusions extending in a longitudinal direction of the second substrate and arranging with spaces and in parallel to each other,
at least two discharge spaces which are formed between the first substrate and the protrusions of the second substrate; and
at least one discharge voltage applying part disposed on an outer surface of the second substrate in an opposite direction to the longitudinal direction of the second substrate, wherein one end of each of the discharge spaces is connected to the at least one discharge voltage applying part.

43. The surface light source device according to claim 42, wherein the protrusions each include a trapezoid shape, an arched shape, a hemisphere shaped or a rectangular shape.

44. The surface light source device according to claim 42, further comprising:
an adhesive which is disposed between edges of the first and second substrates to connect the first substrate with the second substrate.

45. The surface light source device according to claim 44, wherein the adhesive includes a melted lead-glass.

46. The surface light source device according to claim 42, further comprising:
first and second thru-holes in the at least two discharge spaces to uniformly supply discharge gas into to the discharge spaces.

47. The surface light source device according to claim 42, further comprising:
a reflection layer which is disposed on an inner surface of the first substrate;
a first fluorescent layer which is disposed on the reflection layer, and
a second fluorescent layer which is disposed on an inner surface of the second substrate.

48. A method for manufacturing a surface light source body, comprising:
forming a first substrate;
forming a second substrate to include at least two protrusions having a predetermined height with a bottom of the second substrate, wherein the at least two protrusions extend in a longitudinal direction of the second substrate and arrange with spaces and in parallel to each other,
adhering edges of the first and second substrates, wherein inner surface of the protrusions of the second substrate face an inner surface of the first substrate and a space between the first and second substrates is divided into at least two discharge spaces; and
forming at least one discharge voltage applying part on an outer surface of the second substrate in an opposite direction to the longitudinal direction of the second substrate to discharge the discharge spaces.

49. The method according to claim 48, wherein forming the second substrate includes:
heating a glass substrate to reduce a hardness of the glass substrate; and
molding the heated glass substrate to form the at least two protrusions.

50. The method according to claim 49, wherein molding the heated glass substrate includes forming the at least two protrusions as one of a trapezoid shape, an arched shape, a hemisphere shaped and a rectangular shape.

51. The method according to claim 48, wherein adhering edges of the first and second substrates includes:
disposing an adhesive between the edges of the first and second substrates;
firing the adhesive; and
adhering the protrusions to each other by press difference between the first and second substrates.

52. The method according to claim 51, wherein the adhesive includes a melted lead-glass.

53. A method for manufacturing a surface light source body, comprising:
forming a first light source body including a light exit surface and a first fluorescent layer disposed on the light exit surface;
forming a second light source body including a flat receiving space;
forming at least one space-dividing wall in the receiving space of the second light source body to divide the receiving space into at least two discharge spaces;
disposing a second fluorescent layer on the second light source body in which the space-dividing wall is formed;
assembling the first and second source light bodies, wherein the first and second fluorescent layers face each other, and
forming at least one discharge voltage applying part on an outer surface of the assembled first and second light source bodies to generate discharging in the discharge spaces.

54. The method according to claim 53, wherein forming at least one space-dividing wall includes coating a flowable paste at the flat receiving space, the flowable paste having the same material to that of the flat receiving space of the second light source body.

55. The method according to claim 53, wherein forming a second light source body includes:
forming a bottom surface having a flat and rectangular shape; and
forming first to fourth sidewalls vertically extended from edges of the bottom surface such that the first and second sidewalls face each other and the third and fourth sidewalls face each other.

56. The method according to claim 55, wherein forming at least one space-dividing wall includes:
coating a flowable paste on the bottom surface from the first or second sidewall to the second or first sidewall such that a longitudinal direction of the space-dividing wall is substantially perpendicular to the first and second sidewalls and adjacent coated pastes have a predetermined space with each other, and
hardening the coated paste through a firing process.

57. The method according to claim 56, wherein forming at least one space-dividing wall further includes partially removing the flowable paste to form a thru-hole on the space-dividing wall or a zigzag-shaped passage in the discharge spaces before hardening the coated paste.

58. The method according to claim 54, wherein the flowable paste includes mortar or a transparent material.

59. The method according to claim 53, wherein assembling the fist and second light source bodies includes disposing a sealing member on areas on which the first and second light source bodies make contact.

60. The method according to claim 53, wherein forming at least one discharge voltage applying part includes forming a metal tape on the outer surface of the assembled first and second light source bodies in a direction substantially perpendicular to a longitudinal direction of the space-dividing wall.

61. The method according to claim 53, wherein forming at least one discharge voltage applying part includes:
forming attachment portions on the outer surface of the assembled first and second light source bodies in a direction substantially perpendicular to a longitudinal direction of the space-dividing wall, the attachment portions increasing a surface roughness and a surface area of the assembled first and second light source bodies; and
forming the discharge voltage applying part on the attachment portions.

62. The method according to claim 61, wherein forming attachment portions includes spraying sand particles on the outer surface of the assembled first and second light source bodies.

63. The method according to claim 61, wherein forming attachment portions includes dipping the assembled first and second light source bodies into a chemical compound for corroding the assembled first and second light source bodies.

64. The method according to claim 63, wherein the chemical compound includes hydrogen fluoride, hydrofluoric acid.

65. The method according to claim 61, wherein forming the discharge voltage applying part on the attachment portions includes dipping the assembled first and second light source bodies in a melted metal in a direction substantially perpendicular to a surface of the melted metal to attach the melted metal on the attachment portions.

66. The method according to claim 65, wherein the melted metal includes copper, zinc, silver, tin, indium fin oxide or indium zinc oxide.

67. The method according to claim 61, wherein forming the discharge voltage applying part on the attachment portions includes dipping the assembled first and second light source bodies in a melted metal in an inclined direction, with respect to a surface of the melted metal, such that the melted metal is attached on the attachment portions except a portion corresponding to the light exit surface of the first light source body.

68. The method according to claim 61, wherein forming the discharge voltage applying part on the attachment portions includes dipping the assembled first and second light source bodies in a melted metal in an inclined direction, with respect to a surface of the melted metal, such that the melted metal is partially attached on a portion of the attachment portions corresponding to the light exit surface.

69. The method according to claim 53, wherein forming at least one discharge voltage applying part includes:
forming at least one first discharge voltage applying pail by dipping both ends of the assembled first and second light source bodies in a first melted metal having a first melting point and a first hardness;
coupling at least one second discharge voltage applying part with the both ends of the assembled first and second light source bodies on which the first discharge voltage applying part is formed, wherein the second discharge voltage applying part having a second melting pointer higher than the first melting point and a second harness greater than the first hardness; and
sequentially melting and cooling the first and second discharge voltage applying parts to melt and fix the first discharge voltage applying part between the second discharge voltage applying part and the assembled first and second light source bodies.

70. The method according to claim 69, wherein the second discharge voltage applying part has a cap shape, and wherein coupling at least one second discharge voltage applying part includes coupling the second discharge voltage applying part with the both ends of the assembled first and second light source bodies such that the first discharge voltage applying part is covered with the second discharge voltage applying part.

71. The method according to claim 55, wherein forming at least one space-dividing wall includes:
forming first and second sidewall thru-holes on the third and fourth sidewalls of the second light source body;
inserting a sealing bar into the first and second sidewall thru-holes through the flat receiving space between the third and fourth sidewalls such that the sealing bar makes contact with the bottom surface.

72. The method according to claim 71, wherein forming at least one space-dividing wall further includes:
coating a flowable paste on the sealing bar and on the bottom surface, from the first sidewall toward the second sidewall, in a direction perpendicular to the first and second sidewalls, to form the space-dividing wall; and
removing the sealing bar from the second light source body after the space-dividing wall is hardened to make a thru-hole through the space-dividing wall.

73. The method according to claim 72, further comprising:
supplying discharge gas into the discharge spaces through the true-hole at the space-dividing wall;
re-inserting the sealing bar into the first and second sidewall thru-holes at the third and fourth sidewalls and the thru-hole at the space-dividing wall; and
hardening the sealing bar to be coupled to the space-dividing wall and the thru-hole,
whereby the discharge gas is uniformly maintained at each of the discharge spaces.

74. The method according to claim 53, further comprising:
spraying a light reflection material on the flat receiving space and the space-dividing wall to form a light reflection layer on the flat receiving space and the space-dividing wall.

75. The method according to claim 74, wherein the light reflection material includes Al₂O₃ or TiO₃.

76. A method for manufacturing a surface light source device, comprising:
forming a first transparent substrate to include a light exiting area and a sealing area disposed at edges of the light exiting area, the first transparent substrate having a flat and substantially rectangular shape;
forming at least one space-dividing wall on the light exiting area of the first transparent substrate to divide the light exiting area into at least two discharge areas;
forming a light reflection layer on the first transparent substrate and the space-dividing wall;
forming a first fluorescent layer on the light reflection layer,
forming a second transparent substrate having a shape substantially identical to the shape of the first transparent substrate;
forming a second fluorescent layer on the second transparent substrate;
assembling the first transparent substrate, on which the space-dividing wall, the light reflection layer and the first fluorescent layer are disposed, and the second transparent substrate on which the second fluorescent layer is disposed, by employing a sealing member, wherein the first and second fluorescent layers face each other, and
forming at least one discharge voltage applying part on an outer surface of the assembled first and second transparent substrates.

77. The method according to claim 76, wherein forming at least one space-dividing wall includes forming a plurality of the space-dividing wall on the light exiting area of the first transparent such that ends of the space-dividing walls are arranged in a zigzag shape on the light exiting area.

78. The method according to claim 76, wherein forming at least one space-dividing wall includes forming a thru-hole at the space-dividing wall to uniformly distribute discharge gas into the discharge spaces.

79. The method according to claim 76, wherein forming a light reflection layer includes coating a light reflection material on the first transparent substrate and the space-dividing walls through a spraying process to form the light reflection layer.

80. The method according to claim 79, wherein the light reflection material includes Al₂O₃ or TiO₃.

81. The method according to claim 76, wherein forming a first fluorescent layer includes coating a fluorescent material on the light reflection layer through a spraying process to form the first fluorescent layer.

82. The method according to claim 76, wherein assembling the first transparent substrate and the second transparent substrate includes:
forming the sealing member having a rectangular shape and a substantially identical surface area to a surface area of the sealing area of the first transparent substrate;
disposing the sealing member between an area of the first fluorescent layer corresponding to the sealing area of the first transparent substrate and the second fluorescent layer facing the area of the first fluorescent layer; and
forming a sealant on both ends of the sealing member, each facing the first and second fluorescent layers.

83. The method according to claim 82, wherein assembling the first transparent substrate and the second transparent substrate further includes forming the sealant on an area of the first fluorescent layer formed on the space-dividing wall.

84. The method according to claim 76, wherein forming a second fluorescent layer includes:
printing a second fluorescent material on the second transparent substrate except an area of the second transparent substrate corresponding to the space-dividing wall, to generate the second fluorescent layer on the second transparent substrate except the area corresponding to the space-dividing wall.

85. The method according to claim 76, further comprising forming a discharge gas port through the first transparent substrate, the light reflection layer and the first fluorescent layer to supply discharge gas into the discharge spaces.

86. The method according to claim 85, further comprising combining a discharge gas supply pipe with the discharge gas port, wherein the discharge gas supply pipe includes an opened end and a tube-shaped closed end, the opened end is combined with the discharge gas port, and wherein the discharge gas supply pipe further includes a discharge gas impregnated portion impregnated with the discharge gas.

87. The method according to claim 86, further comprising separating the discharge gas supply pipe from the discharge gas port, after supplying the discharge gas into the discharge spaces by heating the discharge gas impregnated portion with a high frequency.

88. The method according to claim 87, further comprising partially melting the discharge gas port to seal the discharge gas port.

89. The method according to claim 86, wherein the discharge gas supply pipe supplies mercury, argon, xenon or krypton.

90. The method according to claim 76, wherein forming at least one discharge voltage applying part includes forming the discharge voltage applying part on the outer surface of the assembled first and second transparent substrates in a direction perpendicular to a longitudinal direction of the space-dividing wall.

91. The method according to claim 90, wherein forming at least one discharge voltage applying part further includes forming the discharge voltage applying part with a band shaped metal.

92. The method according to claim 91, wherein the metal includes lead, copper, zinc, silver, tin, indium tin oxide or indium zinc oxide.

93. A backlight assembly, comprising:
a surface light source device, including:
a light source body including:
a first substrate;
a second substrate which is disposed on the first substrate;
at least two discharge spaces which is formed between first and second substrates; and
at least two fluorescent layers each surrounding the discharge spaces; and
at least one discharge voltage applying part disposed at an outer surface of the light source body to apply discharge voltage to the light source body to generate a visible ray from the discharge gas via the fluorescent layers; and
a receiving container to receive the surface light source body.

94. The backlight assembly according to claim 93, wherein the second substrate of the light source body includes at least two protrusions having a predetermined height with respect to the first substrate, the protrusions extending in a longitudinal direction of the second substrate and arranging with spaces and in parallel to each other, and
wherein the at least two discharge spaces are formed between the first substrate and the at least two protrusions of the second substrate.

95. The backlight assembly according to claim 94, wherein the light source body further includes an adhesive which is disposed between edges of the first and second substrates.

96. The backlight assembly according to claim 93, wherein the light source body further includes:
first to fourth sidewalls each perpendicular to the first substrate, the first and second sidewalls facing each other, and the third and fourth sidewalls facing each other, and
at least one space-dividing wall which is disposed on the first substrate and divides a space between the first and second substrates to form the at least two discharge spaces,
wherein the at least one space-dividing wall extends in a longitudinal direction of the first substrate and the at least one discharge voltage applying part is disposed on the outer surface of the light source body in an opposite direction of the longitudinal direction of the first substrate.

97. The backlight assembly according to claim 93, further comprising an optical member which is disposed on the surface light source device and is received in the receiving container, the optical member diffusing light emitted from the surface light source device.

98. The backlight assembly according to claim 93, wherein the receiving container includes:
a bottom surface which has a size suitable to receive the surface light source device;
sidewalls vertically extended from the bottom surface;
a discharge voltage applying module disposed on a portion of the bottom surface on which the discharge voltage applying pail of the surface light source is disposed, the discharge voltage applying module applying a discharge voltage to the discharge voltage applying part; and
an inverter which is electrically connected to the discharge voltage applying module via a power supply line and applies the discharge voltage to the discharge voltage applying module.

99. The backlight assembly according to claim 98, wherein the surface light source device includes a pair of the discharge voltage applying parts, and the discharge voltage applying module of the receiving container includes first and second discharge voltage applying modules corresponding to the discharge voltage applying parts, respectively.

100. The backlight assembly according to claim 99, wherein each of the first and second discharge voltage applying modules includes a conductive body having a shape substantially identical to each of the discharge voltage applying parts, and a conductive clip integrally formed at both ends of the conductive body, and wherein each of the discharge voltage applying parts is disposed on the conductive body and fixed to each of the first and second discharge voltage applying modules with the conductive clip.

101. A liquid crystal display apparatus, comprising:
a surface light source device, including:
a light source body, including:
a first substrate;
a second substrate which is disposed on the first substrate;
at least two discharge spaces which is formed between first and second substrates; and
at least two fluorescent layers each surrounding the discharge spaces; and
at least one discharge voltage applying part which is disposed at an outer surface of the light source body and applies discharge voltage to the light source body to generate a visible ray from the discharge gas via the fluorescent layers;
a receiving container which receives the surface light source body; and
a liquid crystal display panel which is disposed on the surface light source device and is received in the receiving container, the liquid crystal display panel receiving light emitted from the surface light source device and displaying an image using the receiving light.

102. The liquid crystal display apparatus according to claim 101, wherein the second substrate of the light source body includes at least two protrusions having a predetermined height with respect to the first substrate, the protrusions extending in a longitudinal direction of the second substrate and arranging with spaces and in parallel to each other; and
wherein the at least two discharge spaces are formed between the first substrate and the at least two protrusions of the second substrate.

103. The liquid crystal display apparatus according to claim 102, wherein the light source body further includes an adhesive which is disposed between edges of the first and second substrates.

104. The liquid crystal display apparatus according to claim 101, wherein the light source body further includes:
first to fourth sidewalls each perpendicular to the first substrate, the first and second sidewalls facing each other, and the third and fourth sidewalls facing each other, and
at least one space-dividing wall which is disposed on the first substrate and divides a space between the first and second substrates to form the at least two discharge spaces,
wherein the at least one space-dividing wall extends in a longitudinal direction of the first substrate and the at least one discharge voltage applying part is disposed on the outer surface of the light source body in an opposite direction of the longitudinal direction of the first substrate.

105. The liquid crystal display apparatus according to claim 101, further comprising:
an optical member which is disposed on the surface light source device and is received in the receiving container, the optical member diffusing light emitted from the surface light source device.

106. The liquid crystal display apparatus according to claim 101, further comprising:
a chassis for covering edges of the liquid crystal display panel and being coupled to the receiving container.
